(19) United States
(12) Patent Application Publication
(10) Pub. No.: US 2023/0408945 A1
(43) Pub. Date: Dec. 21, 2023

(54) TONER

(71) Applicant: CANON KABUSHIKI KAISHA, Tokyo (JP)

(72) Inventors: SHOHEI SHIBAHARA, Shizuoka (JP); TOMOHISA SANO, Shizuoka (JP); HIROKI KAGAWA, Shizuoka (JP); TOHRU HIRAMATSU, Shizuoka (JP); KAZUYUKI SATO, Kanagawa (JP)

(21) Appl. No.: 18/307,832

(22) Filed: Apr. 27, 2023

(30) Foreign Application Priority Data
Apr. 28, 2022 (JP) 2022-074942

(51) Int. Cl. G03G 9/097; G03G 9/087; G03G 9/08

(52) U.S. Cl. CPC G03G 9/09716; G03G 9/08755; G03G 9/09725; G03G 9/0819; G03G 9/0825

(57) ABSTRACT

A toner including a polyester resin-including toner particle and a silica fine particle, wherein fragment ions corresponding to a D unit structure are observed in TOF-SIMS measurement of the silica fine particle, where the silica fine particle is dispersed in a specific mixed liquid and a titration operation using sodium hydroxide is performed, the titer is within a specific range, where an area of a peak having a peak top within the range from −25 to −15 ppm in ²⁹Si-NMR measurement of the silica fine particle is denoted by D and an area of a peak having a peak top within the range from more than −19 ppm to −17 ppm or less is denoted by D1, the specific surface area of the silica fine particle, D and D1 satisfy specific relationships, and the polyester resin is present on the surface of the toner particle.

### BACKGROUND OF THE INVENTION

### Field of the Invention

The present disclosure relates to a toner for use in an image forming method such as electrophotography.

### Description of the Related Art

In recent years, efforts have been made to extend the service life and improve environmental stability of copiers and printers, and toners have been required to have stress resistance that can withstand friction inside a cartridge during long-term printing and charging stability such that no charge is lost even in high-temperature and high-humidity environments.

For example, in Japanese Patent Application Publication No. 2000-147831, means for incorporating a polyester resin into toner particles has been studied for the purpose of improving stress resistance.

Further, for example, in Japanese Patent Application Publication No. 2016-167029, means for externally adding silica particles, which were surface-hydrophobized with a cyclic siloxane or dimethylsilicone oil, to toner particles for the purpose of improving the environmental stability was studied.

### SUMMARY OF THE INVENTION

With the toner disclosed in Japanese Patent Application Publication No. 2000-147831, stress resistance is improved. However, since polyester resins tend to absorb moisture in a high-temperature and high-humidity environment, charging of the toner is likely to decrease. As a result, it has been found that downstream of a toner regulating portion of a developing roller, the toner is not held by the developing roller, and image defects called “dripping” that are caused by the toner being printed on non-printing portions are likely to occur.

In addition, with the toner disclosed in Japanese Patent Application Publication No. 2016-167029, a certain effect on initial environmental stability is achieved, but after long-term printing, the surface treatment of the silica fine particles tends to deteriorate, and stable charging performance is difficult to exhibit.

For the above reasons, the development of toners with excellent stress resistance and environmental stability is desired.

The present disclosure provides a toner that demonstrates less dripping and streak occurrence even after long-term printing in a high-temperature and high-humidity environment.

The present disclosure relates to a toner comprising
a toner particle comprising polyester resin, and
a silica fine particle on a surface of the toner particle, wherein
fragment ions corresponding to a structure represented by a following formula (1) are observed in a time-of-flight secondary ion mass spectrometry measurement of the silica fine particle,

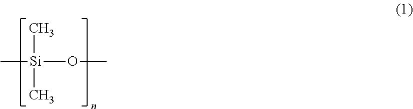

in the formula (1), n represents an integer of 1 or more,
where 2.00 g of the silica fine particle is dispersed in a mixed liquid of 25.0 g of ethanol and 75.0 g of a 20% by mass NaCl aqueous solution and a titration operation using sodium hydroxide is performed, Sn defined by a formula Sn={(a−b)×c×NA}/(d×e) satisfies a following formula (2),

0.05≤Sn≤0.20 (2)
in the formula Sn={(a−b)×c×NA}/(d×e),
a is a NaOH titer (L) required to adjust the mixed liquid, in which the silica fine particle is dispersed, to pH 9.0,
b is a NaOH titer (L) required to adjust the mixed liquid of 25.0 g of ethanol and 75.0 g of a 20% by mass NaCl aqueous solution to pH 9.0,
c is the concentration (mol/L) of the NaOH solution used for titration,
NA is an Avogadro's number,
d is the mass (g) of the silica fine particle, and
e is a BET specific surface area (nm²/g) of the silica fine particle,
where, in a chemical shift obtained by a solid-state ²⁹Si-NMR DD/MAS method of the silica fine particle, an area of a peak having a peak top present in the range from −25 to −15 ppm is denoted by D, the sum of the peak areas of an M unit, a D unit, a T unit, and a Q unit present in the range from −140 ppm to 100 ppm is denoted by S, and a specific surface area of the silica fine particle is denoted by B (m²/g),
a value (D/S)/B of the ratio of (D/S) to B is 5.7×10⁻⁴ to 4.9×10⁻³,
the (D/S)/B measured after washing the silica fine particle with chloroform is 1.7×10⁻⁴ to 4.9×10⁻³,
where an area of a peak having a peak top present in the range from more than −19 ppm to −17 ppm or less in the chemical shift is denoted by D1, a value (D1/D) of the ratio of D1 to D is 0.09 to 0.32, and the polyester resin is present on the surface of the toner particle.

The present disclosure can provide a toner that demonstrates less dripping and streak occurrence even after long-term printing in a high-temperature and high-humidity environment.

Further features of the present invention will become apparent from the following description of exemplary embodiments.

### DESCRIPTION OF THE EMBODIMENTS

Unless otherwise specified, descriptions of numerical ranges such as “from XX to YY” or “XX to YY” in the present disclosure include the numbers at the upper and lower limits of the range. When numerical ranges are described in stages, the upper and lower limits of each of each numerical range may be combined arbitrarily. Further, a monomer unit refers to the reacted form of the monomer substance in the polymer.

The inventors considered the following reason why the abovementioned toner can solve the problem. In order to improve the durability, it is necessary that the toner particle contain a polyester resin and that the polyester resin be present on the surface of the toner particle. As a result, the elasticity of the toner is improved, and the occurrence of streaks can be suppressed even during long-term printing.

In measurements of silica fine particles by time-of-flight secondary ion mass spectrometry TOF-SIMS, it is necessary to observe fragment ions corresponding to the structure represented by the formula (1). Observation of fragment ions represented by the formula (1) indicates that the silica fine particles have been surface-treated with a surface treatment agent having a polydimethylsiloxane structure. Polydimethylsiloxane is hydrophobic, and surface treatment with a treatment agent having a polydimethylsiloxane structure can prevent the silica fine particles from adsorbing moisture to the toner in a high-temperature and high-humidity environment.

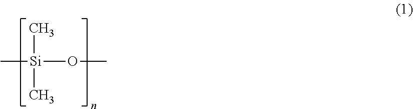

(In Formula (1), n is an integer of from 1 or more (preferably from 1 to 500, more preferably from 1 to 200, still more preferably from 1 to 100, and even more preferably from 1 to 80.)

TOF-SIMS is a method for analyzing the composition of a sample surface by irradiating the sample with ions and analyzing the mass of secondary ions emitted from the sample. Since the secondary ions are emitted from a region several nanometers deep from the sample surface, the structure near the surface of the silica fine particle can be analyzed. The mass spectrum of secondary ions obtained by the measurement represents fragment ions that reflect the molecular structure of the surface treatment agent of the silica fine particle.

Fragment ions corresponding to the structure represented by Formula (1) are observed in measurement of the silica fine particle by TOF-SIMS. In the present disclosure, a structural unit having this structure is defined as a D unit. Where fragment ions of D units are observed by TOF-SIMS, it means that the silica fine particle is surface-treated with a surface treatment agent including D units.

Also, it is necessary to control the amount of Si—OR groups (R is a methyl group, an ethyl group, or a hydrogen atom) in the silica fine particles. The amount of Si—OR groups is the total amount of Si—OR groups on the surface of the silica fine particle base (silica fine particles before surface treatment) and in the surface treatment agent for the silica fine particles. It is considered that since the Si—OR group is polarized and has polarity like Si—O^{δ-}—R^{δ+}, the charging performance can be controlled by the amount thereof. Where the Si—OR amount is small, the charging performance cannot be obtained, and where the Si—OR amount is excessive, the charging performance tends to deteriorate in a high-temperature and high-humidity environment.

It is considered that the Si—OH groups on the surface of the silica fine particle base, among the Si—OR groups, tend to absorb moisture, and thus have a particularly large effect on the charging performance. The amount of Si—OH groups can be evaluated by the value Sn (number/nm²) obtained from the titer of sodium hydroxide. This is because Si—OH of the silica fine particle base and the Si—OH groups of polydimethylsiloxane undergo a neutralization reaction with sodium hydroxide.

Specifically, where 2.00 g of the silica fine particles are dispersed in a mixed liquid of 25.0 g of ethanol and 75.0 g of a 20% by mass NaCl aqueous solution and a titration operation using sodium hydroxide is performed, Sn defined as Sn={(a−b)×c×NA}/(d×e) satisfies the following formula (2),

0.05≤Sn≤0.20 (2)
in the formula Sn={(a−b)×c×NA}/(d×e),
a is a NaOH titer (L) required to adjust the mixed liquid, in which the silica fine particles are dispersed, to pH 9.0,
b is a NaOH titer (L) required to adjust the mixed liquid of 25.0 g of ethanol and 75.0 g of a 20% by mass NaCl aqueous solution to pH 9.0,
c is the concentration (mol/L) of the NaOH solution used for titration,
NA is the Avogadro's number,
d is the mass (g) of the silica fine particles, and
e is a BET specific surface area (nm²/g) of the silica fine particles.

As described above, if Sn is less than 0.05, the number of Si—OH groups, which are charging sites, is too small, resulting in a decrease in charging performance, and where Sn is more than 0.20, moisture adsorption in a high-temperature and high-humidity environment cannot be prevented. Sn is preferably from 0.08 to 0.19, more preferably from 0.10 to 0.18.

Sn can be reduced by lengthening the reaction time during the surface treatment of the silica fine particle base. Meanwhile, Sn can be increased by shortening the reaction time during the surface treatment of the silica fine particle base.

As described above, among the Si—OR groups, the Si—OH groups on the surface of the silica fine particle base tend to absorb moisture and have a large effect on the charging performance. Meanwhile, the Si—OH groups in the surface treatment agent for the silica fine particles are present at some distance from the silica fine particle base, with the structure represented by the above formula (1) or the below-described D2 unit being interposed therebetween. In addition, since two highly hydrophobic methyl groups are bonded to Si, it is considered that the influence of water adsorption is small.

In addition, it is necessary to control the surface treatment state ((D/S)/B, D1/D) of the silica fine particles as the control of the Si—OR groups. The surface treatment state of silica fine particles is calculated by a solid-state ²⁹Si-NMR DD/MAS method. In the DD/MAS measurement method, since all Si atoms in the measurement sample are observed, quantitative information on the chemical bonding state of Si atoms in the silica fine particles can be obtained.

Generally, in solid-state ²⁹Si-NMR, to a Si atom in a solid sample, four types of peaks, namely, an M unit (formula (4)), a D unit (formula (5)), a T unit (formula (6)), and a Q unit (formula (7)), can be observed.

M unit: (Rᵢ)(Rⱼ)(Rₖ)SiO_{1/2} Formula (4)

D unit: (R_{g})(Rₕ)Si(O_{1/2})₂ Formula (5)

T unit: RₘSi(O_{1/2})₃ Formula (6)

Q unit: Si(O_{1/2})₄ Formula (7)

Rᵢ, Rⱼ, Rₖ, R_{g}, Rₕ, and Rₘ in the formulas (4), (5), and (6) are each an alkyl group such as a hydrocarbon group having from 1 to 6 carbon atoms, a halogen atom, a hydroxy group, an acetoxy group, an alkoxy group, or the like bonded to silicon.

When silica fine particles are measured by DD/MAS, the Q unit indicates a peak corresponding to Si atoms in the silica fine particle base before surface treatment. In the present disclosure, when a silica fine particle is surface-treated with a surface treatment agent such as silicone oil, the silica fine particle is assumed to include the portion derived from the surface treatment agent. In addition, a silica fine particle before being surface-treated is also referred to as a silica fine particle base. The BET specific surface area of the silica fine particles after the surface treatment is denoted by B (m²/g). The M unit, D unit, and T unit each show a peak corresponding to the structure of the surface treatment agent for silica fine particles represented by the above formulas (4) to (6).

Each can be identified by the chemical shift value of the solid-state ²⁹Si-NMR spectrum, the chemical shift being from −130 ppm to −85 ppm for the Q unit, from −65 ppm to −51 ppm for the T unit, from −25 ppm to −15 ppm for the D unit, and from 10 to 25 ppm for the M unit, and each unit can be quantified by a respective integrated value. The respective peak integrated values are denoted by Q, T, D, and M, and the sum of these integrated values is denoted by S.

The area of the peak having a peak top present in a of range from −25 ppm to −15 ppm in the chemical shift obtained by a solid-state ²⁹Si-NMR DD/MAS method of the silica fine particles is denoted by D, and the sum of the peak areas of an M unit, a D unit, a T unit, and a Q unit present in the range from −140 ppm to 100 ppm is denoted by S. The BET specific surface area of the silica fine particles is denoted by B (m²/g). At this time, a value (D/S)/B of the ratio of (D/S) to B is from 5.7×10⁻⁴ to 4.9×10⁻³.

The parameter (D/S)/B means the amount of Si atoms per unit surface area that constitute the D unit with respect to the amount of Si atoms in the entire silica fine particle. Here, it is indicated that a silica fine particle for which the fragment represented by the formula (1) is observed in TOF-SIMS and which has a peak at the D unit in the solid-state ²⁹Si-NMR measurement has been surface-treated by a compound having a dimethylsiloxane structure.

In other words, the parameter (D/S)/B represents the amount of dimethylsiloxane on the silica fine particle surface per unit surface area. The smaller the (D/S)/B, the smaller the amount of dimethylsiloxane on the silica fine particle surface, and although such particles, as an external additive, do not hinder flowability, since silanol groups tend to remain on the silica fine particle base surface, charging tends to be decreased by the moisture in a high-temperature and high-humidity environment.

Conversely, the larger the (D/S)/B, the greater the amount of dimethylsiloxane on the silica fine particle surface, but where the amount of D units is excessive, the silica fine particles, as an external additive, inhibit flowability, so the charging performance tends to decrease. In addition, where the dimethylsiloxane treatment is not uniform, silanol groups remain on the surface of the silica fine particle base, so that when the number of printed sheets is large, the charging performance tends to decrease, especially in a high-temperature and high-humidity environment.

Therefore, (D/S)/B needs to be from 5.7×10⁻⁴ to 4.9×10⁻³. When (D/S)/B is less than 5.7×10⁻⁴, moisture adsorption cannot be prevented in a high-temperature and high-humidity environment, and when (D/S)/B is more than 4.9×10⁻³, flowability of the toner decreases and charging performance also decreases. (D/S)/B is preferably from 6.1×10⁻⁴ to 3.7×10⁻³, more preferably from 7.5×10⁻⁴ to 3.3×10⁻³.

(D/S)/B can be increased by increasing the amount of the surface treatment agent during the surface treatment of the silica fine particle base or by using a surface treatment agent including a large amount of a component having a polydimethylsiloxane structure. Meanwhile, (D/S)/B can be reduced by reducing the amount of the surface treatment agent during the surface treatment of the silica fine particle base or by using a surface treatment agent not including a large amount of a component having a polydimethylsiloxane structure.

Also, (D/S)/B measured after washing the silica fine particles with chloroform needs to be from 1.7×10⁻⁴ to 4.9×10⁻³. The washing operation removes the physically adsorbed surface treatment agent, leaving the chemically bonded surface treatment agent. Therefore, (D/S)/B after washing indicates the amount of chemically bonded D units. When (D/S)/B is less than 1.7×10⁻⁴, moisture adsorption cannot be prevented in a high-temperature and high-humidity environment, and when (D/S)/B is greater than 4.9×10⁻³, toner flowability is reduced and charging performance is also reduced.

(D/S)/B after washing the silica fine particles with chloroform is preferably from 2.5×10⁻⁴ to 3.7×10⁻³, more preferably from 3.5×10⁻⁴ to 3.3×10⁻³.

In addition, the area of a peak having a peak top in the range of more than −19 ppm to −17 ppm or less in the chemical shift obtained by the solid-state ²⁹Si-NMR DD/MAS method of silica fine particles is defined as D1. In silica fine particles treated with D units, D1 means a Si—OR group (more specifically —Si(R₂)—OR; R is a methyl group, an ethyl group, or a hydrogen atom) at the end of the D unit. Due to the polarization of D1 at the D unit end, which is highly hydrophobic, the oxygen atom in the Si—OR group has a negative charge δ−.

Therefore, the end of the structure derived from the surface treatment agent having such D1 is in a state with a strong electron-donating character and has the effect of imparting charging performance to the end of the hydrophobic group. Further, as described above, compared with the polar groups such as silanol groups in the Q units present on the surface of the silica fine particle base, the Si—OH groups of D1 at the end of the D units have moderately high hydrophobicity. In addition, as represented by (D/S)/B after washing with chloroform, the D unit is bonded to the silica fine particle base to some extent, and D1 at the end of the D unit is located away from the surface of the silica fine particle base. Therefore, the Si—OH group of D1 suppresses the influence of moisture on the silica fine particle base and is unlikely to lower the charging performance, compared to the silanol group present on the surface of the silica fine particle base.

Therefore, the surface of the silica fine particles is treated with a treatment agent having D units to reduce the amount of silanol groups on the surface of the silica fine particle base and introduce D1 at the end of the D unit, and (D/S)/B, (D/S)/B after washing with chloroform and D1/D are set within the appropriate ranges. By satisfying these conditions, the charge quantity can be increased even in a high-temperature and high-humidity environment. In addition, the presence of D1 can enhance the adhesion between the toner particle and the silica fine particles due to the dipole interaction with the ester sites of the polyester resin present on the toner particle surface. This makes it possible to further prevent moisture adsorption in a high-temperature and high-humidity environment.

The value (D1/D) of the ratio of D1 to D needs to be from 0.09 to 0.32. Where D1 is less than 0.09, the charging performance of D1 cannot be exhibited, and where D1 is greater than 0.32, water adsorption cannot be prevented in a high-temperature and high-humidity environment. D1/D is preferably from 0.10 to 0.30, more preferably from 0.15 to 0.25.

D1/D can be increased by increasing the content ratio of silanol or cyclic siloxane in the components of the treatment agent used for the surface treatment of the silica fine particle base and by lowering the treatment temperature. Meanwhile, D1/D can be reduced by lowering the content ratio of silanol or cyclic siloxane in the components of the treatment agent used for the surface treatment of the silica fine particle base and by raising the treatment temperature.

In addition, the area of a peak having a peak top present in the range of from −23 ppm to −19 ppm in the chemical shift obtained by the solid-state ²⁹Si-NMR DD/MAS method is defined as D2. It is known that among the D units measured on the silica fine particles, a Si atom bonded to the OR group at the end of the D unit corresponds to the peak D1. Also, it is known that a Si atom in a dimethylsiloxane chain corresponds to the peak D2.

Further, the value (D1/D2) of the ratio of D1 to D2 is preferably from 0.15 to 0.42, more preferably from 0.18 to 0.40, and even more preferably from 0.30 to 0.39. Where D1/D2 is 0.15 or more, the effect of exhibiting the charging performance of D1 is enhanced, and where D1/D2 is 0.42 or less, the environmental stability in a high-temperature and high-humidity environment is further improved.

D1/D2 can be increased by increasing the content ratio of silanol or cyclic siloxane in the components of the treatment agent used for the surface treatment of the silica fine particle base. Meanwhile, D1/D2 can be reduced by lowering the content ratio of silanol or cyclic siloxane in the components of the treatment agent used for the surface treatment of the silica fine particle base.

Further, the value (D2/D) of the ratio of D2 to D is preferably from 0.30 to 0.90, more preferably from 0.40 to 0.70, and even more preferably from 0.45 to 0.60. Where D2/D is 0.30 or more, charging stability in a high-temperature and high-humidity environment is further improved, and where D2/D is 0.90 or less, flowability is good and charging performance can be further improved.

When Sp (% by area) is the presence ratio of the polyester resin on the surface of the toner particle, Sp is preferably 50% by area or more. It is more preferably 60% by area or more, still more preferably 70% by area or more. Where Sp is 50% by area or more, durability in long-term printing can be further improved. Although the upper limit of Sp is not particularly limited, it is preferably 100% by area or less, more preferably 98% by area or less, and still more preferably 95% by area or less.

Sp can be controlled by the acid value of the polyester resin. A polyester with a higher acid value is more hydrophilic and tends to be present on the toner surface, and a polyester with a lower acid value is more hydrophobic and tends to be present inside the toner.

Further, the coverage ratio Ssi of the surface of the toner particle with the silica fine particles, which is calculated from an image of the toner surface observed by a scanning electron microscope (SEM), is more preferably 30% by area or more. It is more preferably from 50% by area to 90% by area, still more preferably from 60% by area to 85% by area. When Ssi is 30% by area or more, the charging stability in a high-temperature and high-humidity environment is further improved.

Ssi can be controlled by the amount of silica fine particles added.

In addition, the value (Sp/Ssi) of the ratio of the presence ratio Sp of the polyester resin to the coverage ratio Ssi of the silica fine particles is preferably from 0.70 to 2.50. It is more preferably from 0.40 to 2.00, still more preferably from 0.50 to 1.50. Where Sp/Ssi is 0.70 or more, durability in long-term printing can be further improved, and where Sp/Ssi is 2.50 or less, charging stability in a high-temperature and high-humidity environment is further improved.

Further, the content of the silica fine particles is preferably from 0.3 parts by mass to 2.0 parts by mass, more preferably from 0.18 parts by mass to 0.40 parts by mass, and even more preferably from 0.30 parts by mass to 0.39 parts by mass with respect to 100 parts by mass of the toner particles. Where the content is 0.3 parts by mass or more, the charging performance can be improved even in long-term printing, and where the content is 2.0 parts by mass or less, peeling of the excess amount of silica fine particles from the toner is suppressed, so that charging stability can be further improved.

Further, the number-average particle diameter of the primary particles of the silica fine particles is preferably from 5 nm to 50 nm, more preferably from 10 nm to 40 nm, and even more preferably from 15 nm to 25 nm. When the number-average particle diameter is 5 nm or more, it becomes easier to prevent moisture adsorption by the toner particles, so that charging stability in a high-temperature and high-humidity environment is further improved. When the number-average particle diameter is 50 nm or less, the surface area of the silica fine particles is increased, so that the charge can be further increased.

That is, silica fine particles preferably contain silica fine particles with a small particle diameter and silica fine particles with a large particle diameter. The number-average particle diameter of the primary particles of the small-diameter silica fine particles is preferably from 5 nm to 25 nm, more preferably from 10 nm to 20 nm. Further, the number-average particle diameter of the primary particles of the large-diameter silica fine particles is preferably more than 25 nm and 50 nm or less, more preferably from 30 nm to 40 nm.

The BET specific surface area of the small-diameter silica fine particle is preferably from 100 m²/g to 500 m²/g, more preferably from 150 m²/g to 300 m²/g. Also, the BET specific surface area of the large-diameter silica fine particle is preferably from 10 m²/g to 100 m²/g, more preferably from 30 m²/g to 80 m²/g.

The mass-based content ratio of the small-diameter silica fine particles and the large-diameter silica fine particles is preferably from 20:1 to 5:1, more preferably from 15:1 to 7:1 (small-diameter silica fine particles:large-diameter silica fine particles).

The BET specific surface area B of the silica fine particles after surface treatment is preferably from 40 m²/g to 200 m²/g, more preferably from 100 m²/g to 150 m²/g.

The silica fine particles are preferably surface-treated with at least a compound represented by the following formula (3).

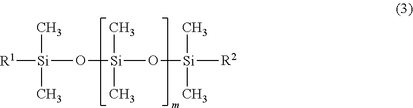

In the formula (3), R¹ and R² are each independently a carbinol group, a hydroxy group, an epoxy group, a carboxy group, an alkyl group (preferably having from 1 to 6 carbon atoms, more preferably from 1 to 3 carbon atoms), or a hydrogen atom. m is the average number of repeating units and is an integer of from 1 to 200 (preferably from 30 to 150, more preferably from 70 to 130).

The surface treatment agent of formula (3) can further improve charging stability in a high-temperature and high-humidity environment. The surface treatment agent to be used is not particularly limited as long as it is a compound represented by the formula (3) and known agents can be used. These may be used alone or in combination of two or more. In addition, two or more types of surface treatment agents having different functional groups may be used sequentially or in a mixture, or two or more types of surface treatment agents having the same functional group, but different viscosities and molecular weight distributions may be used sequentially or in a mixture.

In particular, the silica fine particles are preferably hydrophobized silica particles obtained by heat-treating a silica fine particle base together with a cyclic siloxane and then heat-treating with silicone oil. Where the treatment amount of cyclic siloxane with respect to 100 parts by mass of silica fine particles is X parts by mass, and the treatment amount of silicone oil is Y parts by mass, the ratio (X/Y) of X to Y is preferably from 0.60 to 1.20, more preferably from 0.65 to 1.15, and still more preferably from 0.70 to 1.00.

Where X/Y is 0.60 or more, D1 derived from the cyclic siloxane can further increase the charging of the toner, and where X/Y is 1.20 or less, charging stability in a high-temperature and high-humidity environment can be further improved.

Where the acid value of the polyester resin is Av (mg KOH/g), Av is preferably from 2.0 to 30.0. Av is more preferably from 2.5 to 15.0, still more preferably from 4.0 to 10.0.

Also, the value of (Av/Sp)/Sn calculated from Sp, Av and Sn is preferably from 0.20 to 7.00. (Av/Sp)/Sn is more preferably from 0.40 to 2.00, still more preferably from 0.70 to 0.80.

Where Av is 2.0 or more and (Av/Sp)/Sn is 0.20 or more, the adhesion due to the dipole interaction between the polyester resin and the silica fine particles is further enhanced. Where Av is 30.0 or less and (Av/Sp)/Sn is 7.00 or less, charging stability in a high-temperature and high-humidity environment can be further improved.

Silica fine particles obtained by a known method can be used without any particular limitation as the silica fine particle base which is a base material before surface treatment with silicone oil or the like. Typical examples include fumed silica, wet silica, and sol-gel silica. Also, these may be partially or wholly fused silica.

For the silica fine particle base, it is possible to select, as appropriate, and use a suitable one from fumed silica, wet silica, and the like according to the required properties of individual toners. In particular, fumed silica is excellent in the flowability-imparting effect, and is suitable as a silica fine particle base for use as an external additive for electrophotographic toners.

The silica fine particles obtained by surface treatment on the silica fine particle base for the purpose of imparting hydrophobicity and flowability are used. As a surface treatment method, there is a method of chemically treating with a silicon compound that reacts with or physically adsorbs to the silica fine particle base.

The method of surface-treating the silica fine particle base is not particularly limited and can be carried out by bringing a surface treatment agent containing siloxane bonds into contact with the silica fine particles. From the viewpoint of uniformly treating the surface of the silica fine particle base and easily achieving the above physical properties, it is preferable to bring the surface treatment agent into contact with the silica fine particle base in a dry manner. As will be described hereinbelow, a method of contacting the vapor of a surface treatment agent with raw silica fine particles, or a method of spraying an undiluted solution of the surface treatment agent or a solution obtained by diluting with various solvents to bring the solution into contact with the silica fine particle base can be used.

As a method for surface-treating a silica fine particle base, a method for producing silica fine particles is preferable that includes a step of surface-treating (dry treatment) the silica fine particle base with a cyclic siloxane as the first treatment, and a step of surface-treating (dry treatment) the silica fine particle base after the cyclic siloxane treatment with silicone oil as the second treatment. The silica fine particles are preferably obtained by treating silica fine particles with cyclic siloxane and then treating the treatment product with silicone oil. A method for producing a toner preferably includes a step of preparing silica fine particles obtained by the above method.

Regarding the first treatment, high-temperature treatment with a cyclic siloxane having a low molecular weight can efficiently reduce the amount of silanol groups on the surface of the silica fine particle base and also add a short dimethylsiloxane chain having terminal OH groups to the surface of the silica fine particle base.

The temperature for treating the surface of the silica fine particle base with a cyclic siloxane is preferably 300° C. or higher. Where the temperature is 300° C. or higher, the amount of silanol groups on the surface of the silica fine particle base can be effectively reduced. Moreover, where the treatment temperature is 300° C. or higher, siloxane bonds are generated and broken, and the surface of the silica fine particle base can be treated more uniformly while controlling to obtain uniform siloxane chain lengths.

The temperature for treating the surface of the silica fine particle base with a cyclic siloxane is preferably 310° C. or higher, more preferably 320° C. or higher, and even more preferably 330° C. or higher. Although the upper limit is not particularly limited, it is preferably 380° C. or lower, more preferably 350° C. or lower.

After the cyclic siloxane treatment, the silica fine particle base subjected to the cyclic siloxane treatment is heat-treated with silicone oil as the second treatment. The silicone oil bonds with the terminal OH groups of the component obtained by reaction with the cyclic siloxane in the first treatment, and a long-chain dimethylsiloxane component can be introduced onto the silica fine particle surface. The temperature at which the surface of the silica fine particle base is treated with silicone oil is preferably 300° C. or higher, more preferably 320° C. or higher, and even more preferably 330° C. or higher. Although the upper limit is not particularly limited, it is preferably 380° C. or lower, more preferably 350° C. or lower.

By controlling the treatment amount X with the cyclic siloxane and the treatment amount Y with the silicone oil described above, the amount of silanol component on the surface of the silica fine particle base can be reduced, the above-described D unit amount and D1 amount can be controlled, and the charging stability can be improved, without lowering the flowability of the toner, with a small surface treatment amount.

As the cyclic siloxane, at least one selected from the group consisting of low-molecular-weight cyclic siloxanes having rings with up to 10 members, such as hexamethylcyclotrisiloxane, octamethylcyclotetrasiloxane, decamethylcyclopentasiloxane, and the like, can be used. Among them, octamethylcyclotetrasiloxane is preferred.

In addition, silicone oil indicates an oily substance having a molecular structure with a siloxane bond constituting a main chain, and as long as the above-mentioned formula (3) is satisfied, generally available silicone oils can be used without particular limitation.

Specific examples include silicone oils composed of linear polysiloxane skeletons such as dimethyl silicone oil, alkyl-modified silicone oil, olefin-modified silicone oil, fatty acid-modified silicone oil, alkoxy-modified silicone oil, polyether-modified silicone oil, carbinol-modified silicone oil, and the like.

The treatment time in the first treatment and the second treatment varies depending on the treatment temperature and the reactivity of the surface treatment agent used, but is preferably from 5 min to 300 min, more preferably from 30 min to 240 min, and still more preferably from 50 min to 200 min. The treatment temperature and treatment time of the surface treatment within the above ranges are preferable from the viewpoint of sufficiently reacting the treatment agent with the silica fine particle base and from the viewpoint of production efficiency.

The surface treatment agent is brought into contact with the silica fine particle base in the first treatment preferably by a method of contacting the vapor of the surface treatment agent under reduced pressure or in an inactive gas atmosphere such as a nitrogen atmosphere. By using the vapor contact method, the surface treatment agent that does not react with the silica fine particle surface can be easily removed, and the silica fine particle surface can be adequately covered with modifying groups having appropriate polarity. When using the method of contacting the vapor of the surface treatment agent, the treatment is preferably performed at a treatment temperature equal to or higher than the boiling point of the surface treatment agent. The vapor contact may be carried out in multiple batches.

When the vapor of the surface treatment agent is brought into contact in an inactive gas atmosphere such as a nitrogen atmosphere, the pressure (gauge pressure) of the vapor of the surface treatment agent in a container is preferably from 50 kPa to 300 kPa, more preferably from 150 kPa to 250 kPa.

The toner particle may contain a binder resin. Examples of the binder resin include vinyl resins, polyester resins, and the like, but there is no particular limitation and known resins can be used. The toner particle preferably comprises polyester resins as the binder resin.

Specific examples of vinyl resins include polystyrene and styrenic copolymers such as styrene-propylene copolymer, styrene-vinyl toluene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-octyl methacrylate copolymer, styrene-butadiene copolymer, styrene-isoprene copolymer, styrene-maleic acid copolymer, styrene-maleic acid ester copolymer, and the like, polyacrylic acid esters, polymethacrylic acid esters, polyvinyl acetate, and the like, and these can be used singly or in combination.

Among these, styrenic copolymers and polyester resins are particularly preferred in terms of developing properties, fixing performance and the like. Polyester resins are more preferred.

The components that make up the polyester resin will be described in detail. One or two or more of the following components can be used according to the type and application.

Examples of the divalent carboxylic acid component constituting the polyester resin include the following dicarboxylic acids or derivatives thereof. Benzenedicarboxylic acids such as phthalic acid, terephthalic acid, isophthalic acid and phthalic anhydride and anhydrides or lower alkyl esters thereof, alkyldicarboxylic acids such as succinic acid, adipic acid, sebacic acid, and azelaic acid and anhydrides or lower alkyl esters thereof, alkenyl succinic acids or alkyl succinic acids having an average carbon number of from 1 to 50, and anhydrides or lower alkyl esters thereof; unsaturated dicarboxylic acids such as fumaric acid, maleic acid, citraconic acid and itaconic acid, and anhydrides or lower alkyl esters thereof.

Examples of alkyl groups in the lower alkyl esters include methyl, ethyl, propyl and isopropyl groups.

Meanwhile, examples of the dihydric alcohol component constituting the polyester resin include the following.

Ethylene glycol, polyethylene glycol, 1,2-propanediol, 1,3-propanediol, 1,3-butanediol, 1,4-butanediol, 2,3-butanediol, diethylene glycol, triethylene glycol, 1,5-pentanediol, 1,6-hexanediol, neopentyl glycol, 2-methyl-1,3-propanediol, 2-ethyl-1,3-hexanediol, 1,4-cyclohexanedimethanol (CHDM), hydrogenated bisphenol A, bisphenol represented by formula (I-1) and derivatives thereof, and diols represented by formula (I-2).

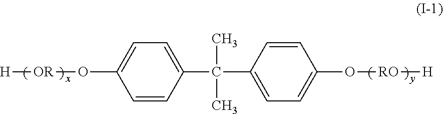

In the formula (I-1), R is an ethylene group or a propylene group, x and y are each integers of 0 or more, and the average value of x+y is from 0 to 10.

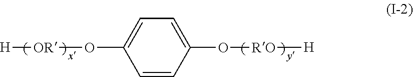

In the formula (I-2), R′ is an ethylene group or a propylene group, x′ and y′ are each an integer of 0 or more, and the average value of x′+y′ is from 0 to 10.

The constituent components of the polyester resin may include a trivalent or higher carboxylic acid component and a trihydric or higher alcohol component in addition to the divalent carboxylic acid component and dihydric alcohol component described above.

The trivalent or higher carboxylic acid component is not particularly limited, and examples thereof include trimellitic acid, trimellitic anhydride, pyromellitic acid, and the like. Examples of the trihydric or higher alcohol component include trimethylolpropane, pentaerythritol, glycerin, and the like.

The constituent components of the polyester resin may include a monovalent carboxylic acid component and a monohydric alcohol component as constituent components in addition to the compounds described above. Specific examples of the carboxylic acid component include palmitic acid, stearic acid, arachidic acid, behenic acid, cerotic acid, heptacosanoic acid, montanic acid, melissic acid, laxelic acid, tetracontanoic acid, pentacontanoic acid, and the like.

In addition, examples of the monohydric alcohol component include behenyl alcohol, ceryl alcohol, melicyl alcohol, and tetracontanol.

A charge control agent may be added to the toner particle.

Organometallic complex compounds and chelate compounds are effective as charge control agents for negative charging, and examples thereof include monoazo metal complex compounds; acetylacetone metal complex compounds; metal complex compounds of aromatic hydroxycarboxylic acids or aromatic dicarboxylic acids; and the like.

Specific examples of commercially available products include SPILON BLACK TRH, T-77, T-95 (Hodogaya Chemical Industry Co., Ltd.), BONTRON (registered trademark) S-34, S-44, 5-54, E-84, E-88, E-89 (Orient Chemical Industries Co., Ltd.).

Examples of positive-charging charge control agents include nigrosine, modified products with fatty acid metal salts and the like; onium salts such as quaternary ammonium salts such as tributylbenzylammonium-1-hydroxy-4-naphthosulfonate and tetrabutylammonium tetrafluoroborate, and phosphonium salts, which are analogues thereof, and lake pigments thereof, triphenylmethane dyes and lake pigments thereof (examples of laking agents include phosphotungstic acid, phosphomolybdic acid, phosphotungstic molybdic acid, tannic acid, lauric acid, gallic acid, ferricyanic acid, ferrocyanic compounds, and the like); metal salts of higher fatty acids; diorganotin oxides such as dibutyltin oxide, dioctyltin oxide, and dicyclohexyltin oxide; organotin borates such as dicyclohexyltin borate, dibutyltin borate, dioctyltin borate, and dicyclohexyltin borate.

Specific examples of commercially available products include TP-302, TP-415 (Hodogaya Chemical Co., Ltd.), BONTRON (registered trademark) N-01, N-04, N-07, P-51 (Orient Chemical Co., Ltd.), COPY BLUE PR (Clariant).

These charge control agents can be used alone or in combination of two or more. From the viewpoint of charge quantity of the toner, the amount of these charge control agents used is preferably from 0.1 parts by mass to 10.0 parts by mass, more preferably from 0.1 parts by mass to 5.0 parts by mass, per 100 parts by mass of the binder resin.

A release agent may be blended into the toner particle as needed to improve fixing performance. The release agent is not particularly limited, and known release agents can be used.

Specific examples of the release agent include petroleum-based waxes such as paraffin wax, microcrystalline wax, petrolatum and derivatives thereof, montan wax and derivatives thereof, hydrocarbon waxes obtained by the Fischer-Tropsch process and derivatives thereof, polyolefin waxes typified by polyethylene and polypropylene, and derivatives thereof, natural waxes such as carnauba wax, candelilla wax, and the like, and derivatives thereof, ester waxes, and the like. Here, the derivatives include oxides, block copolymers with vinyl-based monomers, and graft-modified products.

As the ester wax, monofunctional ester wax, bifunctional ester wax, and multifunctional ester wax such as tetrafunctional and hexafunctional ester waxes can be used.

The toner particle may contain a colorant. Examples of the colorant include organic pigments, organic dyes, inorganic pigments, and the like, but there is no particular limitation and known colorants can be used.

Examples of cyan colorants include copper phthalocyanine compounds and derivatives thereof, anthraquinone compounds, and basic dye lake compounds. Specific examples include C. I. Pigment Blue 1, 7, 15, 15:1, 15:2, 15:3, 15:4, 60, 62, and 66.

The following are examples of magenta colorants. Condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Specific examples include the following.

C. I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254. C. I. Pigment Violet 19.

Examples of yellow colorants include condensed azo compounds, isoindolinone compounds, anthraquinone compounds, azo metal complexes, methine compounds, and allylamide compounds. Specific examples include the following.

C. I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of black colorants include carbon black, and those toned black using the above-mentioned yellow colorants, magenta colorants, cyan colorants, and a magnetic body.

These colorants can be used singly or in a mixture and further in the form of a solid solution. Colorants used in the present invention are selected from the viewpoint of hue angle, chroma, lightness, lightfastness, OHP transparency, and dispersibility in toner particle.

When a magnetic body is used as a colorant for the toner, the magnetic body is mainly composed of magnetic iron oxide such as triiron tetroxide and y-iron oxide, and may contain an element such as phosphorus, cobalt, nickel, copper, magnesium, manganese, aluminum, and silicon. These magnetic bodies preferably have a BET specific surface area of from 2 m²/g to 30 m²/g, more preferably from 3 m²/g to 28 m²/g, as determined by the nitrogen adsorption method. Further, those having a Mohs hardness of from 5 to 7 are preferable. Examples of the shape of the magnetic bodies include polyhedrons, octahedrons, hexahedrons, spheres, needles, scales, etc. Polyhedrons, octahedrons, hexahedrons, spheres, and other shapes with less anisotropy are preferred from the viewpoint of increasing the image density.

The amount of the colorant agent to be added is preferably from 1 part by mass to 20 parts by mass with respect to 100 parts by mass of the binder resin or the polymerizable monomers constituting the binder resin. When magnetic powder is used, the amount thereof is preferably from 20 parts by mass to 200 parts by mass, more preferably from 40 parts by mass to 150 parts by mass, based on 100 parts by mass of the binder resin or the polymerizable monomer constituting the binder resin.

In addition to silica fine particles, the toner may contain other external additives such as inorganic fine particles other than silica fine particles. The toner can be obtained by externally adding silica fine particles and, if necessary, inorganic fine particles other than silica fine particles as an external additive to toner particles. Examples of inorganic fine particles include hydrotalcite compounds, strontium titanate, fatty acid metal salts, alumina, and metal oxide fine particles (inorganic fine particles) such as titanium oxide, zinc oxide fine particles, cerium oxide fine particles and calcium carbonate fine particles.

Further, as other external additives, composite oxide fine particles using two or more types of metals can be used, and two or more types selected in arbitrary combination from these fine particle groups can be used as well.

In addition, resin fine particles or organic-inorganic composite fine particles of resin fine particles and inorganic fine particles can also be used. Preferably, the toner includes titanium oxide particles in addition to silica fine particles as an external additive.

Other external additives may be hydrophobized with a hydrophobizing agent.

Examples of hydrophobizing agents include chlorosilanes such as methyltrichlorosilane, dimethyldichlorosilane, trimethylchlorosilane, phenyltrichlorosilane, diphenyldichlorosilane, t-butyldimethylchlorosilane, vinyltrichlorosilane;
alkoxysilanes such as tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, 7-(2-aminoethyl)aminopropyltrimethoxysilane, 7-(2-aminoethyl)aminopropylmethyldimethoxysilane, and the like;
silazanes such as hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, dimethyltetravinyldisilazane, and the like;
silicone oils such as dimethyl silicone oil, methyl hydrogen silicone oil, methylphenyl silicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, terminally reactive silicone oil, and the like;
siloxanes such as hexamethylcyclotrisiloxane, octamethylcyclotetrasiloxane, decamethylcyclopentasiloxane, hexamethyldisiloxane, octamethyltrisiloxane, and the like; and
fatty acids and metal salts thereof, such as long-chain fatty acids such as undecylic acid, lauric acid, tridecylic acid, dodecylic acid, myristic acid, palmitic acid, pentadecylic acid, stearic acid, heptadecylic acid, arachidic acid, montanic acid, oleic acid, linoleic acid, arachidonic acid, and the like, and salts of these fatty acids with metals such as zinc, iron, magnesium, aluminum, calcium, sodium, lithium, and the like.

Among these, alkoxysilanes, silazanes, and silicone oils are preferably used because hydrophobizing treatment is easy to perform. One of these hydrophobizing agents may be used alone, or two or more thereof may be used in combination.

The amount of the external additive is preferably from 0.05 parts by mass to 20.0 parts by mass with respect to 100 parts by mass of the toner particles. The content of external additives other than silica fine particles is preferably from 0.1 parts by mass to 1.0 part by mass, more preferably from 0.1 parts by mass to 0.5 parts by mass, with respect to 100 parts by mass of toner particles.

The weight-average particle diameter (D4) of the toner is preferably from 3.0 μm to 12.0 μm, more preferably from 4.0 μm to 10.0 μm. When the weight-average particle diameter (D4) is from 3.0 m to 12.0 m, good flowability can be obtained, and the latent image can be developed faithfully.

The complex elastic modulus G′ (60° C.) of the toner at 60° C. is preferably from 4×10⁷ to 8×10¹⁰, more preferably from 4×10⁸ to 1×10¹⁰, and even more preferably from 4×10⁹ to 8×10⁹. G′ (60° C.) represents the durability when the toner is rubbed in the cartridge during long-term printing. Within the above ranges, development streaks can be suppressed without impairing low-temperature fixability. G′ (60° C.) can be controlled by the amount of polyester added.

A method for producing toner particles is not particularly limited, and known methods can be adopted. For example, a method of directly producing a toner in a hydrophilic medium, such as a suspension polymerization method, an emulsion aggregation method, and a dissolution suspension method, can be used. Further, a pulverization method may be used, and the toner obtained by the pulverization method may be thermally spherodized.

For example, in the suspension polymerization method, a polymerizable monomer composition containing polymerizable monomers capable of forming a resin, a release agent, and optionally other additives is granulated in an aqueous medium, and the polymerizable monomers contained in the polymerizable monomer composition are polymerized to obtain toner base particles.

Further, after the polymerization step is completed, the toner base particles may be obtained by washing the produced particles, collecting them by filtration, and drying by known methods.

The temperature may be raised in the second half of the polymerization step. Furthermore, in order to remove unreacted polymerizable monomers or by-products, it is also possible to partially distill off the dispersion medium from the reaction system in the second half of the polymerization step or after the completion of the polymerization step.

A toner can be obtained by adding silica fine particles to the obtained toner particles. Other external additives may be added as necessary. From the viewpoint of dispersibility of the external additive, the mixing time in the external addition step is preferably from 0.5 min to 10.0 min, more preferably from 1.0 min to 5.0 min.

Next, methods for measuring each physical property will be described. Methods for Calculating D1/D, D2/D, D1/D2, (D/S)/B by Solid-State ²⁹Si-NMR DD/MAS Measurement of Silica Fine Particles Solid-state ²⁹Si-NMR measurement of silica fine particles is performed by separating the silica fine particles from the toner surface. A method for separating silica fine particles from the toner surface and the solid-state ²⁹Si-NMR measurement will be described below.

Method for Separating Silica Fine Particles from Toner Surface

When the silica fine particles separated from the toner surface are used as a measurement sample, the silica fine particles are separated from the toner in the following procedure.

A total of 1.6 kg of sucrose (manufactured by Kishida Chemical Co., Ltd.) is added to 1 L of ion-exchanged water and dissolved under heating in a hot water bath to prepare a concentrated sucrose solution. A total of 31 g of the concentrated sucrose solution and 6 mL of CONTAMINON N (a 10% by mass aqueous solution of a neutral detergent for washing precision measuring instruments at pH 7, which consists of a nonionic surfactant, an anionic surfactant, and an organic builder, manufactured by Wako Pure Chemical Industries, Ltd.) are placed in a centrifugation tube to prepare a dispersion liquid. The toner, 10 g, is added to this dispersion liquid, and lumps of the toner are loosened with a spatula or the like.

The centrifugation tube is set in the “KM Shaker” (model: V. SX) manufactured by Iwaki Sangyo Co., Ltd. and shaken for 20 min at 350 reciprocations per minute. After shaking, the solution is transferred in a swing rotor glass tube (50 mL) and centrifuged under the conditions of 3500 rpm and 30 min in a centrifuge.

In the glass tube after centrifugation, toner particles are present in the uppermost layer, and an inorganic fine particle mixture containing silica fine particles is present in the aqueous solution side of the lower layer. The aqueous solution of the upper layer and the aqueous solution of the lower layer are separated and dried to obtain toner particles from the upper layer side and an inorganic fine particle mixture from the lower layer side. The obtained toner particles are used to measure the presence ratio Sp of the polyester resin described hereinbelow. The above centrifugation step is repeated so that the total amount of the inorganic fine particle mixture obtained from the lower layer side is 10 g or more.

Subsequently, 10 g of the resulting inorganic fine particle mixture is added to and dispersed in a dispersion liquid containing 100 mL of ion-exchanged water and 6 mL of CONTAMINON N. The resulting dispersion liquid is transferred to a swing rotor glass tube (50 mL) and centrifuged under the conditions of 3500 rpm and 30 min in a centrifuge.

In the glass tube after centrifugation, the silica fine particles are present in the uppermost layer, and other inorganic fine particles are present in the aqueous solution side of the lower layer. The aqueous solution of the upper layer is collected, centrifugal separation is repeated as necessary, and after sufficient separation, the dispersion liquid is dried and the silica fine particles are collected.

Next, solid-state ²⁹Si-NMR measurement of the silica fine particles recovered from the toner particles is performed under the following measurement conditions.

DD/MAS Measurement Conditions for Solid-State ²⁹Si-NMR Measurement

DD/MAS measurement conditions for solid-state ²⁹Si-NMR measurement are as follows.
Device: JNM-ECX5002 (JEOL RESONANCE)
Temperature: room temperature
Measurement method: DD/MAS method ²⁹Si 450
Sample tube: zirconia 3.2 mmφ
Sample: filled in test tube in powder form
Sample rotation speed: 10 kHz
Relaxation delay: 180 s
Scan: 2000
Calibration standard material: DSS (sodium 3-(trimethylsilyl)-1-propanesulfonate)

After the above measurement, a plurality of silane components with different substituents and bonding groups are peak-separated into the following M unit, D unit, T unit, and Q unit by curve fitting from the solid-state ²⁹Si-NMR spectrum of the silica fine particles.

Curve fitting is performed using JEOL JNM-EX400 software EXcalibur for Windows (registered trademark) version 4.2 (EX series). “1D Pro” is clicked from the menu icon to load the measurement data. Next, “Curve fitting function” is selected from “Command” on the menu bar to perform curve fitting. Curve fitting is performed for each component so that the difference (composite peak difference) between the composite peak obtained by combining the peaks obtained by curve fitting and the peak of the measurement result is minimized.

M unit: (Rᵢ)(Rⱼ)(Rₖ)SiO_{1/2} Formula (4)

D unit: (R_{g})(Rₕ)Si(O_{1/2})₂ Formula (5)

T unit: RₘSi(O_{1/2})₃ Formula (6)

Q unit: Si(O_{1/2})₄ Formula (7)

Rᵢ, Rⱼ, Rₖ, R_{g}, Rₕ, and Rₘ in the formulas (4), (5), and (6) are each an alkyl group such as a hydrocarbon group having from 1 to 6 carbon atoms, a halogen atom, a hydroxy group, an acetoxy group, an alkoxy group, or the like bonded to silicon.

Also, for the D unit peak, waveform separation is performed using the Voigt function, and the area of the peak D1 in the range of more than −19 ppm and not more than −17 ppm and the area of the peak D2 in the range of from −23 ppm to −19 ppm are calculated.

After the peak separation, the integrated value of the D unit where the chemical shift is present in the range of from −25 ppm to −15 ppm is calculated. Further, the total sum S of all integrated values of M, D, T, and Q units present in the range of from −140 ppm to 100 ppm is calculated, the BET specific surface area B (m²/g) of the silica fine particles is obtained by the method described hereinbelow, and the ratio (D/S)/B is calculated. Also, D1/D, D2/D, and D1/D2 are calculated from the peaks D1 and D2 and the integrated value of D obtained by waveform separation.

Furthermore, after the silica fine particles are washed with chloroform as shown hereinbelow, the same NMR measurement is performed to calculate (D/S)/B after washing.

Washing Silica Fine Particles with Chloroform

A total of 100 mL of chloroform and 1 g of silica fine particles are placed into a centrifuge tube and stirred with a spatula or the like. The tube for centrifugation is set on the KM Shaker and shaken for 20 min at 350 reciprocations per minute. After shaking, the mixture is transferred to a swing rotor glass tube and centrifuged under the conditions of 3500 rpm and 30 min in a centrifuge. The supernatant is discarded, 100 mL of chloroform is added again, and shaking and centrifugation are performed twice. Precipitated silica fine particles are collected and vacuum-dried at 40° C. for 24 h to obtain washed silica fine particles.

Method for Measuring Fragment Ions on Silica Fine Particle Surface by Time-of-Flight Secondary Ion Mass Spectrometry (TOF-SIMS)

TOF-SIMS measurement of silica fine particles is performed using the silica fine particles separated from the toner by the above-described method for separating silica fine particles from the toner surface. TRIFT-IV manufactured by ULVAC-PHI, Inc. is used for fragment ion measurement of silica fine particle surface using TOF-SIMS.

The analysis conditions are as follows.
Sample preparation: silica microparticles are caused to adhere to an indium sheet
Primary ion: Au ion.
Accelerating voltage: 30 kV.
Charge neutralization mode: On.
Measurement mode: Positive.
Raster: 200 m.
Measurement time: 60 s.

Whether fragment ions corresponding to the structure represented by the formula (1) are observed is confirmed from the obtained mass profile of secondary ion mass/secondary ion charge number (m/z). For example, where the surface treatment agent is polydimethylsiloxane or cyclic siloxane, fragment ions are observed at m/z=147, 207, and 221 positions.

Monomer Analysis Method for Polyester Resin Components Separation of Resin Component from Toner

The toner is dissolved in tetrahydrofuran (THF), and the solvent is distilled off from the resulting soluble matter under reduced pressure to obtain a tetrahydrofuran (THF) soluble component of the toner. The obtained tetrahydrofuran (THF) soluble component of the toner is dissolved in chloroform to prepare a sample solution having a concentration of 25 mg/mL. A total of 3.5 mL of the obtained sample solution is injected into the below-described device, and under the following conditions, a low-molecular-weight component derived from the release agent having a molecular weight of less than 2000 and a high-molecular-weight component derived from a resin component having a molecular weight of 2000 or more are separated.
Preparative GPC device: Preparative HPLC LC-980 type manufactured by Japan Analytical Industry Co., Ltd.
Preparative column: JAIGEL 3H, JAIGEL 5H (manufactured by Japan Analytical Industry Co., Ltd.)
Eluent: chloroform
Flow rate: 3.5 mL/min

After separating the high-molecular-weight component derived from the resin component, the solvent is distilled off under reduced pressure, and further drying is performed in an atmosphere of 90° C. under reduced pressure for 24 h. When a high-molecular-weight component other than the polyester resin is present, it can be determined whether this component is a polyester resin by conducting a monomer analysis of the polyester resin shown hereinbelow.

The above operation is repeated until about 100 mg of polyester resin is obtained. The obtained polyester resin is dried under reduced pressure at 40° C. for 24 h.

Monomer Analysis of Polyester Resin Components

For the type of monomer of the polyester resin component, a sample of each resin component taken from the toner is analyzed using a pyrolysis GC/MS device under the following conditions.
Measuring device: “Voyager” (trade name, manufactured by Thermo Electron Co., Ltd.).
Thermal decomposition temperature: 600° C.
Column: HP-1 (15 m×0.25 mm×0.25 m).
Inlet: 300° C., Split: 20.0.
Injection volume: 1.2 mL/min.
Temperature rise: 50° C. (4 min)-300° C. (20° C./min).

Method for Measuring Fragment Ions of Polyester Resin on Surface of Toner Particles by Time-of-Flight Secondary Ion Mass Spectrometry (TOF-SIMS) and Calculation of Presence Ratio Sp (% by Area) of Polyester Resin

The TOF-SIMS measurement of the polyester resin on the surface of the toner particles is carried out using the toner particles obtained by separating silica fine particles from the toner by the method for separating the silica fine particles from the toner surface described above.

For fragment ion measurement of polyester resin using TOF-SIMS, TRIFT-IV manufactured by ULVAC-PHI, Inc. is used.

The analysis conditions are as follows.
Sample Preparation: toner particles are attached to an indium sheet.
Primary ion: Au ion.
Accelerating voltage: 30 kV.
Charge neutralization mode: On.
Measurement mode: Positive.
Raster: 200 m.
Measurement time: 60 s.

From the obtained mass profile of secondary ion mass/secondary ion charge number (m/z), it is confirmed whether fragment ions of the monomer species identified by the above monomer analysis are observed. A value At is obtained by dividing this value by the total amount of ions counted in the toner particle measurement.

A similar measurement is also performed on the polyester resin separated and purified by the abovementioned method, and the value Ap is obtained by dividing the obtained secondary ion mass/secondary ion charge number (m/z) by the total amount of ions. The value (At/Ap) of the ratio of At to Ap is defined as the presence ratio Sp of the polyester resin on the toner particle surface. The arithmetic mean value of 100 toner particles is taken.

Regarding the determination of whether the polyester resin is present on the surface of the toner particles, when the fragment ion peak derived from the monomer species identified by the above monomer analysis is detected, it is determined that the polyester resin is present on the surface of the toner particles.

Measurement of Acid Value of Polyester Resin

The acid value is the number of milligrams of potassium hydroxide required to neutralize the acid contained in 1 g of sample. The acid value is measured according to JIS K 0070-1992, and more specifically according to the following procedure.

A total of 1.0 g of phenolphthalein is dissolved in 90 mL of ethyl alcohol (95% by volume), ion-exchanged water is added to make 100 mL, and a phenolphthalein solution is obtained.

A total of 7 g of special grade potassium hydroxide is dissolved in 5 mL of water, and ethyl alcohol (95% by volume) is added to make 1 L. After allowing the solution to stand in an alkali-resistant container for 3 days so as to avoid contact with carbon dioxide gas etc., filtration is performed to obtain a potassium hydroxide solution. The resulting potassium hydroxide solution is stored in an alkali-resistant container. The factor of the potassium hydroxide solution is the titer determined from the amount of potassium solution required for neutralization when 25 mL of 0.1 mol/L hydrochloric acid is taken in an Erlenmeyer flask, several drops of the phenolphthalein solution are added, and titration is performed with the potassium hydroxide solution. The 0.1 mol/L hydrochloric acid is prepared according to JIS K 8001-1998.

A 2.0 g sample of the pulverized crystalline polyester is precisely weighed into a 200 mL Erlenmeyer flask, 100 mL of a mixed solution of toluene/ethanol (2:1) is added, and dissolution is performed over 5 h. Then, several drops of the phenolphthalein solution are added as an indicator, and titration is performed using the potassium hydroxide solution. The end point of titration is when the light red color of the indicator continues for about 30 sec.

As a blank test, titration is performed in the same manner as in the above operation, except that no sample is used (that is, only a mixed solution of toluene/ethanol (2:1) is used).

(3) The acid value is calculated by substituting the obtained results into the following formula.

A=[(C−B)×f×5.61]/S

Here, A is the acid value (mg KOH/g), B is the amount of potassium hydroxide solution added in the blank test (mL), and C is the amount of potassium hydroxide solution added in the main test (mL), f is the potassium hydroxide solution factor, and S is the mass of the sample (g).

Method for Measuring Complex Elastic Modulus G′ of Toner

The hardness of the toner is evaluated by the complex elastic modulus G′ at 60° C. As a measuring device, a rotating plate type rheometer “ARES” (manufactured by TA Instruments) is used.

A sample obtained by weighing 0.1 g of toner and press-molding into a disk shape having a diameter of 8.0 mm and a thickness of 1.5±0.3 mm using a tablet molding machine at room temperature (25° C.) is used as a measurement sample.

The sample is mounted on a parallel plate with a diameter of 8.0 mm, heated from room temperature (25° C.) to 100° C. over 5 min, held for 3 min, and cooled to 25° C. over 10 min. After that, the temperature is maintained at 25° C. for 30 min before starting the measurement. At this time, the sample is set so that the initial normal force is 0. Also, as described hereinbelow, in subsequent measurements, the influence of the normal force can be canceled by setting the automatic tension adjustment (Auto Tension Adjustment ON). Measurement is performed under the following conditions.
(1) A parallel plate with a diameter of 8.0 mm is used.
(2) Frequency: 1 Hz.
(3) The initial value of applied strain (Strain) is set to 0.05%.
(4) The measurement is performed at a temperature increase rate (Ramp Rate) of 2.0 [° C./min] in the temperature range of from 25° C. to 70° C. The measurement is performed under the following setting conditions of the automatic adjustment mode. The measurement is performed in the automatic strain adjustment mode (Auto Strain).
(5) The maximum strain (Max Applied Strain) is set to 20.0%.
(6) The maximum torque (Max Allowed Torque) is set to 200.0 [g cm] and the minimum torque (Min Allowed Torque) is set to 0.2 [g cm].
(7) Strain Adjustment is set to 20.0% of Current Strain. In the measurement, an automatic tension adjustment mode (Auto Tension) is adopted.
(8) Auto Tension Direction is set to Compression.
(9) Initial Static Force is set to 10 g and Auto Tension Sensitivity is set to 10.0 g.
(10) Auto Tension operating conditions are set to Sample Modulus: 1.00×10⁶ Pa or more.

Under the above conditions, the complex elastic modulus G′ at 60° C. is obtained by measurement at a frequency of 1 Hz.

Method for Measuring Si—OH Content of Silica Fine Particles

The amount of Si—OH in the silica fine particles can be determined by the following method using the silica fine particles separated from the toner by the method for separating the silica fine particles from the toner surface described above.

A sample liquid 1 is prepared by mixing 25.0 g of ethanol and 75.0 g of a 20% by mass sodium chloride aqueous solution. Further, 2.00 g of silica fine particles are accurately weighed in a glass bottle, and a sample liquid 2 is prepared by adding a solvent obtained by mixing 25.0 g of ethanol and 75.0 g of a 20% by mass sodium chloride aqueous solution. The sample liquid 2 is stirred with a magnetic stirrer for 5 min or longer to disperse the silica fine particles.

Then, the pH change of each of sample liquids 1 and 2 is measured while dropping 0.1 mol/L sodium hydroxide aqueous solution at 0.01 mL/min. The titer (L) of sodium hydroxide aqueous solution when pH 9.0 is reached is recorded. The amount Sn (/nm²) of Si—OH per 1 nm² can be calculated from the following formula.

Sn={(a−b)×c×NA}/(d×e)
a: NaOH titer (L) of sample liquid 2.
b: NaOH titer (L) of sample liquid 1.
c: concentration of NaOH solution used for titration (mol/L).
NA: Avogadro's number.
d: mass of silica fine particles (g).
e: BET specific surface area of silica fine particles (nm²/g: converted from the specific surface area (m²/g) obtained below).

Method for Measuring BET Specific Surface Area of Silica Fine Particles

The BET specific surface area of silica fine particles is measured by the following procedure. As a measuring device, “Automatic Specific Surface Area/Pore Size Distribution Measuring Device TriStar 3000 (manufactured by Shimadzu Corporation)”, which adopts a gas adsorption method based on a constant volume method as a measuring method, is used. Setting of measurement conditions and analysis of measurement data are performed using the dedicated software “TriStar 3000 Version 4.00” provided with the device. A vacuum pump, a nitrogen gas pipe, and a helium gas pipe are connected to the device. Using nitrogen gas as the adsorption gas, the value calculated by the BET multipoint method is defined as the BET specific surface area.

The BET specific surface area is calculated as follows. First, nitrogen gas is adsorbed on the silica fine particles, and the equilibrium pressure P (Pa) in the sample cell at that time and the nitrogen adsorption amount Vₐ (mol·g⁻¹) of the magnetic bodies are measured. Then, an adsorption isotherm is obtained in which a relative pressure Pᵣ, which is the value obtained by dividing the equilibrium pressure P (Pa) in the sample cell by the saturated vapor pressure P₀ (Pa) of nitrogen, is plotted against the abscissa, and the nitrogen adsorption amount Vₐ (mol·g⁻¹) is plotted against the ordinate. Next, a monomolecular layer adsorption amount Vₘ (mol·g⁻¹), which is an adsorption amount necessary to form a monomolecular layer on the surface of the silica fine particle, is obtained by using the following BET formula.

Pᵣ/Vₐ(1−Pᵣ)=1/(Vₘ×C)+(C−1)×Pᵣ/(Vₘ×C)

(Here, C is a BET parameter, which is a variable that varies depending on the type of measurement sample, the type of adsorbed gas, and the adsorption temperature.)

Where Pᵣ is the X-axis and Pᵣ/Vₐ(1−Pᵣ) is the Y-axis, the BET formula can be interpreted as a straight line with a slope of (C−1)/(VₘχC) and an intercept of 1/(Vₘ×C) (this straight line is called a BET plot).

Slope of straight line=(C−1)/(Vₘ×C).

Intercept of straight line=1/(Vₘ×C).

By plotting the measured values of Pᵣ and the measured values of Pᵣ/Vₐ (1−Pᵣ) on a graph and drawing a straight line by using the least squares method, the values of slope and intercept of the straight line can be calculated. Using these values, Vₘ and C can be calculated by solving the simultaneous equations for the slope and the intercept. Further, the BET specific surface area S (m²/g) of the silica fine particles is calculated based on the following formula from the Vₘ calculated above and the cross-sectional area occupied by the nitrogen molecule (0.162 nm²).

S=Vₘ×N×0.162×10⁻¹⁸

(Here, N is Avogadro's number (mol¹)).

Specifically, measurements using this device are performed according to the following procedure.

The tare of a well-washed and dried dedicated glass sample cell (stem diameter ⅜ inch, volume 5 mL) is accurately weighed. Then, using a funnel, 0.1 g of silica fine particles is placed into this sample cell. The sample cell containing silica fine particles is set in a “PRETREATMENT DEVICE VACUUM PREP 061 (manufactured by Shimadzu Corporation)” to which a vacuum pump and a nitrogen gas pipe are connected, and vacuum degassing is continued at 23° C. for 10 h.

The vacuum degassing is gradually performed while adjusting a valve so that the silica fine particles are not sucked into the vacuum pump. The pressure inside the cell gradually decreases in the course of degassing and finally reaches 0.4 Pa (about 3 mTorr).

After the vacuum degassing is completed, nitrogen gas is gradually injected to return the inside of the sample cell to atmospheric pressure, and the sample cell is detached from the pretreatment device. The mass of the sample cell is accurately weighed, and the exact mass of the silica fine particles is calculated from the difference from the tare. At this time, the sample cell is covered with a rubber plug during weighing so that the silica fine particles in the sample cell are not contaminated with moisture in the atmosphere.

Next, a dedicated isothermal jacket is attached to the sample cell containing the silica fine particles. A dedicated filler rod is inserted into this sample cell, and the sample cell is set in the analysis port of the device. The isothermal jacket is a cylindrical member with the inner surface made of a porous material and the outer surface made of an impermeable material. The isothermal jacket can suck up liquid nitrogen to a certain level by capillary action.

Next, a free space of the sample cell, including the connecting device is measured. The free space is calculated by measuring the volume of the sample cell by using helium gas at 23° C., then measuring the volume of the sample cell after cooling the sample cell with liquid nitrogen by similarly using helium gas, and converting from the difference in volume. In addition, the saturated vapor pressure P₀(Pa) of nitrogen is separately and automatically measured using a P₀ tube built into the device.

Next, after the inside of the sample cell is vacuum degassed, the sample cell is cooled with liquid nitrogen while vacuum degassing is continued. Thereafter, nitrogen gas is introduced stepwise into the sample cell to cause the silica fine particles to adsorb nitrogen molecules. At this time, since an adsorption isotherm can be obtained by measuring the equilibrium pressure P (Pa) at any time, this adsorption isotherm is converted into a BET plot.

The points of the relative pressure Pᵣ for collecting data are set to a total of 6 points of 0.05, 0.10, 0.15, 0.20, 0.25, and 0.30. A straight line is drawn on the obtained measurement data by the least squares method, and Vₘ is calculated from the slope and intercept of the straight line. Further, using this Vₘ value, the BET specific surface area of the silica fine particles is calculated as described above.

Method for Calculating Coverage Ratio Ssi of Surface of Toner Particles by Silica Fine Particles

The coverage Ratio Ssi of the toner particle surface by the silica fine particles is calculated from a backscattered electron image acquired by observation with a scanning electron microscope (SEM). A backscattered electron image is also called a “composition image”, and the smaller the atomic number, the darker the detected image, and the larger the atomic number, the brighter the detected image. The backscattered electron image of the toner is acquired under the following observation conditions. A method for acquiring a backscattered electron image of the toner and a method for calculating the coverage ratio of the toner particle surface by the silica fine particles are described hereinbelow.

Method for Acquiring Backscattered Electron Image of Toner
Apparatus used: ULTRA PLUS, manufactured by Carl Zeiss Microscopy Co., Ltd.
Accelerating voltage: 1.0 kV.
WD: 2.5 mm.
Aperture size: 30.0 m.
Detection signal: EsB (energy selective backscattered electron).
EsB Grid: 700V.
Observation magnification: 20,000 times.
Contrast: 63.0±5.0% (reference value).
Brightness: 38.0±5.0% (reference value).
Resolution: 1024×768 pixels.
Pretreatment: toner is sprinkled on carbon tape (no Pt vapor deposition).

Contrast and brightness are set, as appropriate, according to the state of the apparatus used. In addition, the accelerating voltage and EsB Grid are set so as to achieve items such as acquisition of structural information on the outermost surface of the toner, prevention of charge-up of an undeposited sample, and selective detection of high-energy backscattered electrons. For the observation field of view, a portion where the curvature of the toner is small is selected.

Method for Calculating Silica Coverage Ratio of Toner

The silica coverage ratio is acquired by analyzing the backscattered electron image of the toner outermost surface obtained by the above method using image processing software ImageJ (developed by Wayne Rashand). The procedure is shown below.

First, the backscattered electron image to be analyzed is converted to 8-bit from Type in the Image menu. Next, from Filters in the Process menu, the median diameter is set to 2.0 pixels to reduce image noise. Next, the entire backscattered electron image is selected using the Rectangle Tool on the toolbar. Subsequently, Threshold is selected from Adjust in the Image menu, and a luminance threshold (from 85 to 128 (256 gradations)) is specified so that only luminance pixels derived from the silica fine particles in backscattered electrons are selected. Finally, Measure is selected from the Analyze menu, and the value of the area ratio (% by area) of the luminance selected portion in the backscattered electron image is calculated.

The above procedure is performed for 20 fields of view for the toner to be evaluated, and the arithmetic average value is taken as the coverage ratio Ssi of the toner particle surface by the silica fine particles.

Method for Measuring Number-Average Particle Diameter of Silica Fine Particles

The number-average particle diameter of the silica fine particles is measured from a secondary electron image acquired by observing the toner surface with a scanning electron microscope (SEM).

Method for Acquiring Secondary Electron Image of Toner
Apparatus used: ULTRA PLUS, manufactured by Carl Zeiss Microscopy Co., Ltd.
Accelerating voltage: 1.0 kV.
WD: 2.5 mm.
Aperture size: 30.0 m.
Detection signal: SE2 (secondary electron image).
Observation magnification: 50,000 times.
Resolution: 1024×768 pixels.
Pretreatment: toner is sprinkled on carbon tape (no Pt vapor deposition).

The maximum diameter of 100 primary particles of silica fine particles on the toner particle surface is measured from the resulting secondary electron image, and the average value is taken as the number-average particle diameter of the silica particles.

Measurement of Amount of Silica Fine Particles

The content of silica fine particle is determined by measuring the mass of the silica fine particles and the toner particles obtained by the method for separating the silica fine particles from the toner surface.

Method for Measuring Weight-Average Particle Diameter (D4) of Toner

The weight-average particle diameter (D4) of the toner is calculated by using a precision particle diameter distribution measuring device “Coulter Counter Multisizer 3” (registered trademark, manufactured by Beckman Coulter, Inc.), which is based on a pore electrical resistance method and equipped with a 100 m aperture tube, and dedicated software “Beckman Coulter Multisizer 3 Version 3.51” (manufactured by Beckman Coulter, Inc.) provided therewith for setting measurement conditions and analyzing the measurement data, performing measurements at the number of effective measurement channels of 25,000 and analyzing the measurement data.

For the electrolytic aqueous solution used for measurement, a solution in which special grade sodium chloride is dissolved in ion-exchanged water so that the concentration is about 1% by mass, for example, “ISOTON II” (manufactured by Beckman Coulter, Inc.) can be used.

Before performing the measurement and analysis, the dedicated software is set as follows.

At the “Change Standard Measurement Method (SOM) Screen” of the dedicated software, the total number of counts in control mode is set to 50,000 particles, the number of measurements is set to 1, and a value obtained using “Standard Particle 10.0 μm” (manufactured by Beckman Coulter Co., Ltd.) is set as the Kd value. The threshold and noise level are automatically set by pressing the threshold/noise level measurement button. Also, the current is set to 1600 μA, the gain is set to 2, the electrolytic solution is set to ISOTON II, and the flash of aperture tube after measurement is checked.

At the “Pulse to Particle Diameter Conversion Setting Screen” of the dedicated software, the bin interval is set to logarithmic particle diameter, the particle diameter bin is set to a 256 particle diameter bin, and the particle diameter range is set to from 2 m to 60 m.

The specific measurement method is as follows.
(1) About 200 ml of the electrolytic aqueous solution is placed in a 250 ml round-bottom glass beaker exclusively provided for Multisizer 3, the beaker is set on a sample stand, and a stirrer rod is stirred counterclockwise at 24 revolutions/second. Then, the dirt and air bubbles inside the aperture tube are removed using the “Flush Aperture Tube” function of the dedicated software.
(2) About 30 ml of the electrolytic aqueous solution is placed in a 100 ml flat-bottomed glass beaker, and about 0.3 ml of a diluent obtained by 3-fold by mass dilution of “CONTAMINON N” (a 10% by mass aqueous solution of a neutral detergent for washing precision measuring instruments at pH 7, which consists of a nonionic surfactant, an anionic surfactant, and an organic builder, manufactured by Wako Pure Chemical Industries, Ltd.) as a dispersing agent with ion-exchanged water is added thereto.
(3) A predetermined amount of ion-exchanged water is placed in a water tank of an ultrasonic disperser “Ultrasonic Dispersion System Tetora 150” (manufactured by Nikkaki Bios Co., Ltd.) having an electrical output of 120 W and containing two oscillators with an oscillation frequency of 50 kHz that are built in with a phase shift of 180 degrees, and about 2 ml of the CONTAMINON N is added to the water tank.
(4) The beaker of (2) is set in the beaker fixing hole of the ultrasonic disperser and the ultrasonic disperser is operated. The height position of the beaker is adjusted so that the resonance state of the liquid level of the electrolytic aqueous solution in the beaker is maximized.
(5) While the electrolytic aqueous solution in the beaker in (4) above is being irradiated with ultrasonic waves, about 10 mg of toner is added little by little to the electrolytic aqueous solution and dispersed. Then, the ultrasonic dispersion treatment is continued for another 60 sec. In the ultrasonic dispersion, the temperature of water in the water tank is appropriately adjusted to from 10° C. to 40° C.
(6) The electrolytic aqueous solution of (5) in which the toner is dispersed is dropped using a pipette into the round-bottomed beaker of (1) installed in the sample stand, and the measured concentration is adjusted to about 5%. The measurement is continued until the number of measured particles reaches 50,000.
(7) The measurement data are analyzed with the dedicated software provided with the device, and the weight-average particle diameter (D4) is calculated. The weight-average particle diameter (D4) is the “average diameter” on the analysis/volume statistics (arithmetic mean) screen when graph/vol % is set using the dedicated software.

### Examples

Although the present invention will be described in more detail below with production examples and examples, these are not intended to limit the present invention in any way. All parts in the following formulations are parts by mass.

Production Example of Silica Fine Particles 1

Untreated dry silica as small-diameter inorganic fine particles (number-average particle diameter of primary particles 15 nm, BET specific surface area 200 m²/g) and untreated dry silica as large-diameter inorganic fine particles (number-average particle diameter of primary particles is 35 nm, BET specific surface area 50 m²/g) were loaded at a mass ratio of 10:1 and heated to 330° C. in a fluidized state created by stirring. The inside of the reactor was replaced with nitrogen gas, the reactor was sealed, and octamethylcyclotetrasiloxane was sprayed and mixed as a first surface treatment agent by using a spray nozzle until the gauge pressure reached 200 kPa. Thereafter, the reaction was conducted by continuing heating and stirring for 1 h to carry out a coating treatment.

After the treatment, the inside of the reaction system was replaced with a nitrogen atmosphere and heated to 330° C. again. Subsequently, as a second surface treatment agent, 10 parts of dimethyl silicone oil (KF-96-50CS, manufactured by Shin-Etsu Chemical Co., Ltd.) was sprayed on 100 parts of untreated dry silica, and then the coating treatment was similarly carried out for 1 h to obtain silica fine particles 1. Table 1-2 shows the physical properties of the silica fine particles 1.

Production Examples of Silica Fine Particles 2 to 5, 12, 14, and 19

Silica fine particles 2 to 5, 12, 14, 19 were obtained in the same manner as in the production example of silica fine particles 1, except that the reaction time of the first surface treatment agent and the number of parts and the treatment temperature of the second surface treatment agent were changed as shown in Table 1-1.

Regarding the structure of the second treatment component in Table 1-1, the structure of the substituent of the compound represented by the formula (3) is shown.

Production Examples of Silica Fine Particles 6 to 11, 13, 15, 18, and 20 Silica fine particles 6 to 11, 13, 15, 18, and 20 were obtained in the same manner as in the production example of silica fine particles 1, except that the silica fine particle base was loaded as shown in Table 1-1, the second surface treatment agent was a double terminal carbinol modified silicone oil (KF-6002, manufactured by Shin-Etsu Chemical Co., Ltd.), and the BET specific surface area of the untreated dry silica to be loaded, the reaction time of the first surface treatment agent, the number of parts of the second surface treatment agent and the treatment temperature of the second surface treatment agent were changed as shown in Table 1-1.

Production Example of Silica Fine Particles 21

Untreated dry silica (BET specific surface area: 200 m²/g) was loaded as inorganic fine particles and heated to 250° C. in a fluidized state created by stirring. The inside of the reactor was replaced with nitrogen gas, the reactor was sealed, and 25 parts of hexamethyldisilazane was sprayed as the first surface treatment agent to 100 parts of untreated dry silica using a spray nozzle. Thereafter, a reaction was performed by continuing heating and stirring for 1 h to carry out a coating treatment, whereby silica fine particles 21 were obtained.

TABLE 1-1

| | | First treatment component | | | Second treatment component | | | | |
|---|---|---|---|---|---|---|---|---|---|
| | | | Fill/kPa | Reaction | | | | Number of | |
| Silica fine | Base | | (number of | time | End R1 group | End R2 group | | parts for | Treatment |
| particle No. | BET/m²/g | | parts of HMDS) | h | structure | structure | m | treatment | temperature |
| 1 | 200 50 | D4 | 200 | 1 | Methyl group | Methyl group | 101 | 10 | 330° C. |
| | (10:1) | | | | | | | | |
| 2 | 200 50 | D4 | 200 | 1 | Methyl group | Methyl group | 105 | 12 | 330° C. |
| | (10:1) | | | | | | | | |
| 3 | 200 50 | D4 | 200 | 2 | Methyl group | Methyl group | 95 | 8 | 330° C. |
| | (10:1) | | | | | | | | |
| 4 | 200 50 | D4 | 200 | 1 | Methyl group | Methyl group | 87 | 8 | 330° C. |
| | (10:1) | | | | | | | | |
| 5 | 200 50 | D4 | 200 | 3 | Methyl group | Methyl group | 102 | 10 | 330° C. |
| | (10:1) | | | | | | | | |
| 6 | 30 | D4 | 240 | 1 | Carbinol group | Carbinol group | 60 | 3 | 330° C. |
| 7 | 200 | D4 | 200 | 1 | Carbinol group | Carbinol group | 93 | 10 | 330° C. |
| 8 | 380 | D4 | 200 | 1 | Carbinol group | Carbinol group | 99 | 10 | 330° C. |
| 9 | 21 | D4 | 200 | 1 | Carbinol group | Carbinol group | 103 | 9 | 330° C. |
| 10 | 400 | D4 | 200 | 1 | Carbinol group | Carbinol group | 103 | 10 | 330° C. |
| 11 | 20 | D4 | 200 | 1 | Carbinol group | Carbinol group | 97 | 9 | 330° C. |
| 12 | 200 50 | D4 | 200 | 1 | Methyl group | Methyl group | 91 | 9 | 320° C. |
| | (10:1) | | | | | | | | |
| 13 | 200 50 | D4 | 200 | 1 | Carbinol group | Carbinol group | 93 | 15 | 350° C. |
| | (10:1) | | | | | | | | |
| 14 | 200 50 | D4 | 200 | 1 | Methyl group | Methyl group | 106 | 9 | 310° C. |
| | (10:1) | | | | | | | | |
| 15 | 200 50 | D4 | 200 | 1 | Carbinol group | Carbinol group | 93 | 16 | 350° C. |
| | (10:1) | | | | | | | | |
| 16 | 200 50 | D4 | 200 | 1 | Carbinol group | Carbinol group | 106 | 15 | 350° C. |
| | (10:1) | | | | | | | | |
| 18 | 200 50 | D4 | 200 | 1 | Carbinol group | Carbinol group | 106 | 9 | 360° C. |
| | (10:1) | | | | | | | | |
| 19 | 200 50 | D4 | 200 | 1 | — | — | — | 0 | 250° C. |
| | (10:1) | | | | | | | | |
| 20 | 200 50 | D4 | 200 | 5 | Carbinol group | Carbinol group | 103 | 9 | 340° C. |
| | (10:1) | | | | | | | | |
| 21 | 200 | HMDS | 25 | 1 | — | — | — | — | 250° C. |

In Table 1-1, “Base BET/m²/g” indicates the BET specific surface area of the silica fine particle base. For silica fine particles 1 to 5 and 12 to 20, it is indicated in the “Base BET/m²/g” column that silica fine particles with a small particle diameter having a BET specific surface area of 200 m²/g and silica fine particles with a large particle diameter having a BET specific surface area of 50 m²/g are used at a small particle diameter silica:large particle diameter silica mass ratio of 10:1. D4 indicates octamethylcyclotetrasiloxane and HMDS denotes hexamethyldisilazane.

Regarding the fill, the number of parts of HMDS is indicated.

TABLE 1-2

| | | | | | | | | | Number- | |
|---|---|---|---|---|---|---|---|---|---|---|
| | | | | (D/S)/B | (D/S)/B | | | | average | |
| Silica fine | | | | before | after | | | | particle | |
| particle No. | Sn | D/S | B | washing | washing | D1/D | D1/D2 | D2/D | diameter/nm | X/Y |
| 1 | 0.15 | 0.18 | 117 | 1.5E−03 | 9.7E−04 | 0.20 | 0.38 | 0.53 | 18 | 0.75 |
| 2 | 0.13 | 0.21 | 105 | 2.0E−03 | 1.2E−03 | 0.11 | 0.20 | 0.55 | 19 | 0.62 |
| 3 | 0.16 | 0.17 | 137 | 1.2E−03 | 7.9E−04 | 0.30 | 0.60 | 0.50 | 18 | 1.15 |
| 4 | 0.19 | 0.12 | 210 | 5.7E−04 | 4.9E−04 | 0.19 | 0.52 | 0.37 | 7 | 2.46 |
| 5 | 0.05 | 0.21 | 125 | 1.7E−03 | 1.0E−03 | 0.27 | 0.50 | 0.54 | 19 | 1.00 |
| 6 | 0.17 | 0.13 | 27 | 4.8E−03 | 4.8E−03 | 0.25 | 0.38 | 0.66 | 38 | 4.71 |
| 7 | 0.16 | 0.20 | 130 | 1.5E−03 | 1.0E−03 | 0.18 | 0.30 | 0.60 | 17 | 0.76 |
| 8 | 0.17 | 0.22 | 247 | 8.9E−04 | 6.5E−04 | 0.20 | 0.31 | 0.65 | 5 | 0.73 |
| 9 | 0.17 | 0.13 | 40 | 3.3E−03 | 2.9E−03 | 0.25 | 0.38 | 0.66 | 47 | 0.88 |
| 10 | 0.18 | 0.17 | 280 | 6.1E−04 | 5.5E−04 | 0.20 | 0.38 | 0.53 | 4 | 0.73 |
| 11 | 0.16 | 0.13 | 35 | 3.7E−03 | 3.3E−03 | 0.25 | 0.38 | 0.66 | 51 | 0.88 |
| 12 | 0.09 | 0.14 | 125 | 1.1E−03 | 7.8E−04 | 0.12 | 0.38 | 0.32 | 17 | 0.64 |
| 13 | 0.16 | 0.17 | 110 | 1.5E−03 | 1.4E−03 | 0.16 | 0.20 | 0.80 | 19 | 0.73 |
| 14 | 0.09 | 0.14 | 120 | 1.2E−03 | 8.2E−04 | 0.11 | 0.40 | 0.28 | 18 | 0.62 |
| 15 | 0.16 | 0.17 | 105 | 1.6E−03 | 1.5E−03 | 0.10 | 0.11 | 0.91 | 18 | 0.73 |
| 16 | 0.15 | 0.17 | 115 | 1.5E−03 | 1.3E−03 | 0.13 | 0.15 | 0.87 | 19 | 0.64 |
| 18 | 0.15 | 0.15 | 120 | 1.3E−03 | 1.1E−03 | 0.08 | 0.11 | 0.73 | 18 | 0.73 |
| 19 | 0.38 | 0.10 | 178 | 5.6E−04 | 4.5E−04 | 0.40 | 0.50 | 0.80 | 14 | — |
| 20 | 0.04 | 0.22 | 120 | 1.8E−03 | 1.7E−03 | 0.05 | 0.10 | 0.50 | 18 | 1.00 |
| 21 | 0.10 | — | 110 | — | — | — | — | — | 17 | — |

In Table 1-2, B is the specific surface area B (m²/g) of the silica fine particles. (D/S)/B before washing is the value of the ratio (D/S)/B in the analysis of the silica fine particles by the solid-state ²⁹ Si-NMR DD/MAS method. (D/S)/B after washing is the value of the ratio (D/S)/B after washing the silica fine particles with chloroform.

For example, a value of “1.5E-03” indicates “1.5×10⁻³”.

Production Example of Polyester Resin 1
Terephthalic acid: 75 parts
Bisphenol A—propylene oxide 2 mol adduct: 100 parts
Tetrabutoxytitanate: 0.125 parts

The above polyester monomers were loaded into an autoclave equipped with a decompression device, a water separator, a nitrogen gas introduction device, a temperature measurement device, and a stirring device, and the reaction was carried out at 200° C. for 5 h under a nitrogen atmosphere under normal pressure. After that, 2.1 parts of trimellitic acid and 0.120 parts of tetrabutoxytitanate were added, the reaction was performed at 220° C. for 3 h and then under reduced pressure of from 10 mmHg to 20 mmHg for 2 h to obtain a polyester resin 1.

The physical properties of the obtained polyester resin 1 were acid value=8.3 mg KOH/g, weight-average molecular weight (Mw)=11000, and glass transition temperature=72.5° C.

Production Examples of Polyester Resins 2 to 5

Polyester resins 2 to 5 were obtained in the same manner as in the production example of polyester resin 1, except that the types and amounts of raw materials such as terephthalic acid and bisphenol A—propylene oxide 2-mol adduct were changed as shown in Table 2. Table 2 shows the physical properties.

TABLE 2

| | Raw material \textcircled{1} | | Raw material \textcircled{2} | | Raw material \textcircled{3} | | |
|---|---|---|---|---|---|---|---|
| | | Number of | | Number of | | Number of | Acid |
| | Type | parts | Type | parts | Type | parts | value |
| Polyester resin 1 | TPA | 75 | BPA-PO | 100 | | | 8.3 |
| Polyester resin 2 | TPA | 84 | BPA-PO | 100 | | | 2.5 |
| Polyester resin 3 | TPA | 65 | BPA-PO | 100 | TMA | 24 | 26.0 |
| Polyester resin 4 | TPA | 91 | BPA-PO | 100 | | | 1.5 |
| Polyester resin 5 | TPA | 61 | BPA-PO | 100 | TMA | 27 | 32.0 |

In the table, TPA indicates terephthalic acid, BPA-PO indicates bisphenol A—propylene oxide 2-mol adduct, and TMA indicates trimellitic acid. The unit of acid value is mg KOH/g.

Production Example of Toner 1

A total of 2.3 parts of tricalcium phosphate was added to 900 parts of ion-exchanged water heated to 60° C., and stirring was conducted at 10000 rpm using a T. K. HOMOMIXER (manufactured by Tokushu Kika Kogyo Co., Ltd.) to obtain an aqueous medium. Resin-containing monomers were prepared by uniformly dissolving and mixing the following materials with a propeller stirrer at 100 rpm.
Styrene 45.0 parts
n-Butyl acrylate 25.0 parts
Polyester resin 1 4.0 parts

In addition, the following materials were dispersed using an attritor (manufactured by Mitsui Miike Kakoki Co., Ltd.) to obtain a particulate colorant-containing monomer.
Styrene 30.0 parts
Carbon black 7.4 parts
Charge control agent BONTRON E-88 (manufactured by Orient Chemical Co., Ltd.) 1.0 parts
Wax HNP-51 (manufactured by Nippon Seiro Co., Ltd.) 9.0 parts

Next, the particulate colorant-containing monomer and the resin-containing monomer were uniformly mixed to obtain a polymerizable monomer composition. Thereafter, the polymerizable monomer composition was heated to 60° C., and then the polymerizable monomer composition was loaded into the aqueous medium to granulate the polymerizable monomer composition and form particles of the polymerizable monomer composition.

Then, 10.0 parts of tert-butyl peroxypivalate as a polymerization initiator was added to the particles, and granulation was continued for 10 min.

After that, the mixture was transferred to a propeller stirrer, and the reaction was conducted at 75° C. for 5 h while stirring at 100 rpm. Then, the temperature was raised to 85° C., and further reaction was conducted for 5 h to carry out polymerization reaction. After completion of the polymerization reaction, the slurry containing the particles was cooled to room temperature (25° C.), hydrochloric acid was added to the slurry to dissolve tricalcium phosphate, and filtration and washing with water were performed to obtain wet colored particles. Then, the wet colored particles were dried at a temperature of 40° C. for 72 h to obtain toner particles 1.

Production of Toner 1

Using an FM mixer (“FM-10B” manufactured by Nippon Coke Kogyo Co., Ltd.) at a rotation speed of 3500 rpm, 100 parts of toner particles 1, 0.6 parts of silica fine particles 1, and 0.2 parts of titanium oxide particles (number-average particle diameter 1.2 m) were added and mixed for 180 sec to obtain a toner mixture.

After that, coarse particles were removed using a sieve of 300 mesh (48 m opening) to obtain toner 1. Table 3 shows the production conditions and physical properties.

Toners 2 to 33

Toners 2 to 33 were produced by performing the same operations as in the production example of toner 1, except that the type of polyester resin, the amount of polyester resin particles added, the type of silica fine particles, and the number of parts of silica fine particles added in the production of toner 1 were changed as shown in Table 3. Table 3 shows the production conditions and physical properties.

TABLE 3

| | | | | | Presence/absence | | | | |
|---|---|---|---|---|---|---|---|---|---|
| | | Amount (parts) | silica | Amount (parts by | of fragment ions | | | | |
| Toner | Polyester | of polyester | particles | mass) of silica | represented by | | | | |
| No. | resin No. | resin added | No. | particles added | formula (1) | Sp | Ssi | Sp/Ssi | (Av/Sp)/Sn |
| 1 | 1 | 4.0 | 1 | 0.6 | Present | 90 | 63 | 1.43 | 0.74 |
| 2 | 1 | 4.0 | 2 | 0.6 | Present | 90 | 63 | 1.43 | 0.85 |
| 3 | 1 | 4.0 | 3 | 0.6 | Present | 90 | 63 | 1.43 | 0.69 |
| 4 | 1 | 4.0 | 4 | 0.6 | Present | 90 | 63 | 1.43 | 0.58 |
| 5 | 1 | 4.0 | 5 | 0.6 | Present | 90 | 63 | 1.43 | 2.22 |
| 6 | 1 | 4.0 | 6 | 0.6 | Present | 90 | 63 | 1.43 | 0.65 |
| 7 | 2 | 4.0 | 1 | 0.6 | Present | 90 | 63 | 2.41 | 0.22 |
| 8 | 3 | 4.0 | 5 | 0.6 | Present | 90 | 63 | 0.71 | 5.56 |
| 9 | 4 | 4.0 | 1 | 0.6 | Present | 90 | 63 | 3.50 | 0.19 |
| 10 | 5 | 4.0 | 5 | 0.6 | Present | 90 | 63 | 0.68 | 7.11 |
| 11 | 1 | 4.0 | 6 | 0.6 | Present | 90 | 63 | 1.43 | 0.69 |
| 12 | 1 | 4.0 | 7 | 0.6 | Present | 90 | 63 | 1.43 | 0.65 |
| 13 | 1 | 4.0 | 8 | 0.6 | Present | 90 | 63 | 1.43 | 0.65 |
| 14 | 1 | 4.0 | 9 | 0.6 | Present | 90 | 63 | 1.43 | 0.62 |
| 15 | 1 | 4.0 | 10 | 0.6 | Present | 90 | 63 | 1.43 | 0.69 |
| 16 | 1 | 3.0 | 1 | 0.3 | Present | 77 | 32 | 1.43 | 0.87 |
| 17 | 1 | 2.5 | 1 | 2.0 | Present | 60 | 85 | 1.43 | 1.11 |
| 18 | 1 | 5.0 | 1 | 0.2 | Present | 98 | 28 | 1.43 | 0.68 |
| 19 | 1 | 2.5 | 1 | 2.1 | Present | 60 | 88 | 1.43 | 1.11 |
| 20 | 1 | 4.0 | 11 | 0.6 | Present | 90 | 63 | 1.43 | 1.23 |
| 21 | 1 | 4.0 | 12 | 0.6 | Present | 90 | 63 | 1.43 | 0.95 |
| 22 | 1 | 4.0 | 13 | 0.6 | Present | 90 | 63 | 1.43 | 0.95 |
| 23 | 1 | 4.0 | 14 | 0.6 | Present | 90 | 63 | 1.43 | 0.69 |
| 24 | 1 | 4.0 | 15 | 0.6 | Present | 90 | 63 | 1.43 | 0.95 |
| 25 | 1 | 4.0 | 16 | 0.6 | Present | 90 | 63 | 1.43 | 0.95 |
| 26 | 1 | 2.0 | 1 | 0.6 | Present | 52 | 63 | 0.83 | 1.28 |
| 27 | 1 | 1.8 | 1 | 0.6 | Present | 48 | 61 | 0.79 | 1.39 |
| 28 | Acrylamide | 4.0 | 1 | 0.6 | Present | — | 63 | — | — |
| | resin | | | | | | | | |
| 30 | 1 | 4.0 | 18 | 0.6 | Present | 90 | 63 | 1.43 | 1.39 |
| 31 | 1 | 4.0 | 19 | 0.6 | Present | 90 | 63 | 1.43 | 2.78 |
| 32 | 1 | 4.0 | 20 | 0.6 | Present | 90 | 63 | 1.43 | 0.44 |
| 33 | 1 | 4.0 | 21 | 0.6 | Absent | 90 | 63 | 1.43 | 1.11 |

The following evaluations were performed using the obtained toners.

### Evaluation of Image Streaks at Initial Stage and After Durability

Image streaks are vertical streaks of about 0.5 mm that occur when the toner breaks due to friction inside the cartridge during long-term printing and represent image defects that are likely to be observed when a full-surface halftone image is output.

A modified LBP712Ci (manufactured by Canon Inc.) was used as the image forming apparatus. The process speed of the apparatus was modified to 250 mm/sec. Necessary adjustments were made so that image formation could be performed under this condition. Also, the toner was removed from the black and cyan cartridges, and 50 g of the toner to be evaluated was filled instead in each cartridge. The toner laid-on level was set to 1.0 mg/cm².

Image streaks during continuous use under normal temperature and humidity (23° C., 60% RH) were evaluated. As evaluation paper, XEROX4200 paper (75 g/m², manufactured by XEROX) was used.

Under a normal temperature and normal humidity environment, an E letter image with a print percentage of 1% was printed on 1000 sheets in intermittent-continuous use in which two images were output every 4 sec, and then a 50% halftone image was output on the entire surface, and the presence or absence of streaks was observed. The evaluation result at this time was defined as initial image streaks (initial streaks). Further, after 14000 sheets were printed in intermittent-continuous use, a 50% halftone image was output on the entire surface, and the presence or absence of streaks was observed. The evaluation result at this time was defined as image streaks after durability (durability streaks). A to C were determined to be good. Table 4 shows the evaluation results.

### Evaluation Criteria for Development Streaks

A: No streaks or toner lumps occurred.
B: There are no spotty streaks, but there are 1 or 2 small toner lumps.
C: 1 to 2 spot-like streaks or 3 to 4 small toner lumps at the edges.
D: 1 to 2 spot-like streaks or 5 to 6 small toner lumps on the entire surface.
E: 3 or more spot-like streaks or 7 or more small toner lumps on the entire surface.

Evaluation of Charging Performance and Dripping in High-Temperature and High-Humidity Environment

HP LaserJet Enterprise M609dn was used with the process speed modified to 500 mm/sec in consideration of fixing performance evaluation on a high-speed machine.

In addition, the apparatus was modified so that an external power supply could be connected to change the transfer bias, and charging stability and dripping were evaluated.

After allowing the imaging tester and the toner cartridge filled with the evaluation toner to stand in a high-temperature and high-humidity environment of 32.5° C./80% RH for 20 or 30 days, a test was conducted to print 20,000 copies of a horizontal line pattern in which four-dot horizontal lines were printed at intervals of 176 dots with the imaging tester.

At the initial stage of the above test and after printing 20,000 sheets, the charge quantity (C/g) of the toner on the developing carrier member in the toner cartridge was measured using a blow-off powder charge quantity measuring device TB-200 (manufactured by Toshiba Chemical Co., Ltd.) and charging performance in a high-temperature and high-humidity environment was evaluated. The greater the absolute value of the numerical value of charging performance, the higher the charging performance and environmental stability. In addition, the 20,000th image sample in the above test was visually observed, and dripping was evaluated according to the following criteria. Evaluation ranks of charge quantity and dripping were determined and evaluated as follows.

### Evaluation Criteria for Charge Quantity

S: Charge quantity less than −25.0 μC/g.
A: Charge quantity is −25.0 μC/g or more and less than −20.0 μC/g.
B: Charge quantity is −20.0 μC/g or more and less than −15.0 μC/g.
C: Charge quantity is −15.0 μC/g or more and less than −10.0 μC/g.
D: Charge quantity is −10.0 μC/g or more.

Evaluation Criteria for Dripping
S: No dripping occurred in the developing unit in evaluation after allowing to stand for 30 days.
A: No dripping occurred in the developing unit in evaluation after allowing to stand for 20 days.
B: Toner is observed to fall on the developing blade in evaluation after allowing to stand for 20 days, but there is no problem with the image.
C: Dripping occurred in one place on the image in evaluation after allowing to stand for 20 days.
D: Dripping occurred in two or more places on the image in evaluation after allowing to stand for 20 days.

In this evaluation, the occurrence of “toner dripping” refers to a state in which the toner is not held on the developing roller and falls onto the developing blade downstream of the toner regulating portion of the developing roller. Where image formation is continued in a state in which toner dripping has occurred, the inside of the image forming body and the recording paper will be contaminated, resulting in deterioration of image quality.

TABLE 4

| | | | | Triboelectricity | | |
|---|---|---|---|---|---|---|
| | | | | after allowing | Triboelectricity | |
| Example | Toner | | Vertical | to stand in HH | rank after allowing | |
| No. | No. | G′(60° C.) | streaks | (μC/g) | to stand in HH | Dripping |
| 1 | 1 | 6 × 10⁹ | A | −26.1 | S | S |
| 2 | 2 | 6 × 10⁹ | A | −20.1 | A | A |
| 3 | 3 | 6 × 10⁹ | A | −20.2 | A | A |
| 4 | 4 | 6 × 10⁹ | A | −21.0 | A | A |
| 5 | 5 | 6 × 10⁹ | A | −21.2 | A | A |
| 6 | 6 | 6 × 10⁹ | A | −21.0 | A | A |
| 7 | 7 | 6 × 10⁹ | A | −21.5 | A | A |
| 8 | 8 | 6 × 10⁹ | A | −20.1 | A | A |
| 9 | 9 | 6 × 10⁹ | A | −18.6 | B | B |
| 10 | 10 | 6 × 10⁹ | A | −17.5 | B | B |
| 11 | 11 | 6 × 10⁹ | A | −20.2 | A | A |
| 12 | 12 | 6 × 10⁹ | A | −21.7 | A | A |
| 13 | 13 | 6 × 10⁹ | A | −22.5 | A | A |
| 14 | 14 | 6 × 10⁹ | A | −19.4 | B | B |
| 15 | 15 | 6 × 10⁹ | A | −18.5 | B | B |
| 16 | 16 | 6 × 10⁹ | A | −20.6 | A | A |
| 17 | 17 | 6 × 10⁸ | A | −22.5 | A | A |
| 18 | 18 | 6 × 10¹⁰ | A | −14.5 | C | C |
| 19 | 19 | 6 × 10⁷ | B | −22.5 | A | A |
| 20 | 20 | 6 × 10⁹ | A | −21.5 | A | D |
| 21 | 21 | 6 × 10⁹ | A | −22.7 | A | D |
| 22 | 22 | 6 × 10⁹ | A | −16.4 | B | B |
| 23 | 23 | 6 × 10⁹ | A | −19.5 | B | B |
| 24 | 24 | 6 × 10⁹ | A | −20.8 | A | A |
| 25 | 25 | 6 × 10⁹ | A | −18.5 | B | B |
| 26 | 26 | 6 × 10⁸ | A | −20.8 | A | A |
| 27 | 27 | 6 × 10⁷ | B | −18.5 | B | B |
| C.E. 1 | 28 | 6 × 10⁹ | D | −12.5 | C | C |
| C.E. 3 | 30 | 6 × 10⁹ | A | −9.0 | D | D |
| C.E. 4 | 31 | 6 × 10⁹ | A | −9.5 | D | D |
| C.E. 5 | 32 | 6 × 10⁹ | A | −7.5 | D | D |
| C.E. 6 | 33 | 6 × 10⁹ | A | −6.0 | D | D |

In the Table, “C.E.” indicates “Comparative Example”. HH indicates “high-temperature and high-humidity environment”

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2022-074942, filed Apr. 28, 2022, which is hereby incorporated by reference herein in its entirety.

What is claimed is:

1. A toner comprising
a toner particle comprising polyester resin, and
a silica fine particle on a surface of the toner particle, wherein
fragment ions corresponding to a structure represented by a following formula (1) are observed in a time-of-flight secondary ion mass spectrometry measurement of the silica fine particle, 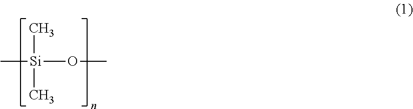
in the formula (1), n represents an integer of 1 or more,
where 2.00 g of the silica fine particle is dispersed in a mixed liquid of 25.0 g of ethanol and 75.0 g of a 20% by mass NaCl aqueous solution and a titration operation using sodium hydroxide is performed, Sn defined by a formula Sn={(a−b)×c×NA}/(d×e) satisfies a following formula (2),
0.05≤Sn≤0.20 (2)
in the formula Sn={(a−b)×c×NA}/(d×e),
a is a NaOH titer (L) required to adjust the mixed liquid, in which the silica fine particle is dispersed, to pH 9.0,
b is a NaOH titer (L) required to adjust the mixed liquid of 25.0 g of ethanol and 75.0 g of a 20% by mass NaCl aqueous solution to pH 9.0,
c is the concentration (mol/L) of the NaOH solution used for titration,
NA is an Avogadro's number,
d is the mass (g) of the silica fine particle, and
e is a BET specific surface area (nm²/g) of the silica fine particle,
where, in a chemical shift obtained by a solid-state ²⁹Si-NMR DD/MAS method of the silica fine particle, an area of a peak having a peak top present in the range from −25 to −15 ppm is denoted by D, the sum of the peak areas of an M unit, a D unit, a T unit, and a Q unit present in the range from −140 to 100 ppm is denoted by S, and a specific surface area of the silica fine particle is denoted by B (m²/g),
a value (D/S)/B of the ratio of (D/S) to B is 5.7×10⁻⁴ to 4.9×10⁻³,
the (D/S)/B measured after washing the silica fine particle with chloroform is 1.7×10⁻⁴ to 4.9×10⁻³,
where an area of a peak having a peak top present in the range from more than −19 ppm to −17 ppm or less in the chemical shift is denoted by D1, a value (D1/D) of the ratio of D1 to D is 0.09 to 0.32, and
the polyester resin is present on the surface of the toner particle.

2. The toner according to claim 1, wherein where a presence ratio of the polyester resin on the surface of the toner particle is denoted by Sp (area %), the Sp is 50% by area or more.

3. The toner according to claim 1, wherein in the chemical shift, where the area of a peak having a peak top present in the range of from −23 ppm to −19 ppm is denoted by D2, the value (D1/D2) of the ratio of D1 to D2 is 0.15 to 0.42.

4. The toner according to claim 1, wherein the value (D2/D) of the ratio of D2 to D is 0.30 to 0.90.

5. The toner according to claim 1, wherein
where a coverage ratio of the surface of the toner particle by the silica fine particle that is calculated from an image of a surface of the toner observed by a scanning electron microscope is denoted by Ssi,
the Ssi is 30% by area or more.

6. The toner according to claim 1, wherein
where a presence ratio of the polyester resin on the surface of the toner particle is denoted by Sp (area %), and
a coverage ratio of the surface of the toner particle by the silica fine particle that is calculated from an image of a surface of the toner observed by a scanning electron microscope is denoted by Ssi,
the value (Sp/Ssi) of the ratio of the Sp to the Ssi is 0.70 to 2.50.

7. The toner according to claim 1, wherein a content of the silica fine particle is 0.3 to 2.0 parts by mass with respect to 100 parts by mass of the toner particles.

8. The toner according to claim 1, wherein the silica fine particle has a number-average particle diameter of primary particle of 5 nm to 50 nm.

9. The toner according to claim 1, wherein the silica fine particle is surface treated with at least a compound represented by a following formula (3): 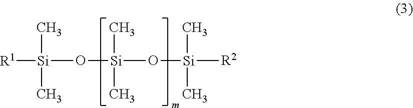
where, R¹ and R² in the formula (3) are each independently a carbinol group, a hydroxy group, an epoxy group, a carboxy group, an alkyl group, or a hydrogen atom.
m is an integer of from 1 to 200.

10. The toner according to claim 1, wherein
where a presence ratio of the polyester resin on the surface of the toner particle is denoted by Sp (area %), and
an acid value of the polyester resin is denoted by Av (mg KOH/g),
the Av is 2.0 to 30.0, and
(Av/Sp)/Sn calculated from the Sp, the Av and the Sn is 0.20 to 7.00.

11. The toner according to claim 1, wherein the silica fine particle is a silica fine particle treated with cyclic siloxane and then treated with silicone oil.
